(19) United States
(12) Patent Application Publication
(10) Pub. No.: US 2026/0354421 A1
(43) Pub. Date: Nov. 12, 2026

(54) FOAMING INGREDIENT

(71) Applicant: SOCIÉTÉ DES PRODUITS NESTLÉ S.A., Vevey (CH)

(72) Inventors: Sheila RUIZ BARBERO, Lausanne (CH); Marina DUPAS-LANGLET, Savigny (CH); Lisa Marcela LAMOTHE, Lausanne 26 (CH); Vincent Daniel Maurice MEUNIER, Epalinges (CH); Christophe Joseph Etienne SCHMITT, Servion (CH); Sarah MICHEL, Epalinges (CH)

(21) Appl. No.: 19/120,904

(22) PCT Filed: Oct. 18, 2023
(86) PCT No.: PCT/EP2023/078943

§ 371 Date: Apr. 14, 2025

(30) Foreign Application Priority Data
Oct. 18, 2022 (EP) 22202224.6

(51) Int. Cl. A23L 2/54; A23F 5/40; A23L 2/39; A23L 29/30

(52) U.S. Cl. CPC A23L 2/54; A23F 5/40; A23L 2/39; A23L 29/30

(57) ABSTRACT

The present invention relates to a foaming ingredient comprising one or more branched polysaccharide. The present invention also relates to a beverage powder comprising said foaming ingredient, a method for preparing said foaming ingredient and the use of said foaming ingredient to prepare a foaming beverage or foodstuff.

### FIELD OF THE INVENTION

The present invention relates to a foaming ingredient comprising entrapped gas. The present invention also relates to a beverage powder comprising a foaming ingredient, a method for preparing a foaming ingredient and the use of a foaming ingredient to prepare a foaming beverage or foodstuff.

### BACKGROUND TO THE INVENTION

Foaming ingredients which, upon addition of a liquid, are able to provide a foam have many uses. For example, these foaming ingredients may be used to provide foam in powdered milkshakes and cappuccino beverages. Soluble coffee beverage products which produce cappuccino beverages are usually a dry mix of coffee powder, a soluble creamer base, sugar and a foaming ingredient. The soluble foaming ingredient may contain pockets of gas which, upon dissolution of the powder, produce foam. Therefore, upon the addition of water or milk, a whitened coffee beverage, which has a foam on its upper surface, is formed; the beverage resembling, to a greater or lesser extent, traditional Italian cappuccino.

There is a consumer demand for clean label foaming ingredients, however, whilst it may be possible to replace some named ingredients by clean label alternatives, there are several drawbacks that may associated with the clean label alternatives, for example: (1) the clean label alternatives may reduce shelf life; (2) the foam properties may not be as good as the reference product; and/or (3) the clean label alternatives may increase the viscosity of the liquid slurry increasing production costs.

### SUMMARY OF THE INVENTION

The inventors have surprisingly found that branched polysaccharides may be used as an alternative to glucose syrup in foaming ingredients, without compromising on shelf life, foaming properties and production costs. Indeed, the branched polysaccharides may actually significantly improve internal packing, so that the gas loading and gas retention are improved compared to linear polysaccharides. Moreover, the foaming properties are not compromised and ideal viscosities can be reached prior to spray drying to assure processability.

In one aspect, the present invention provides a foaming ingredient comprising carbohydrate and entrapped gas, wherein the carbohydrate comprises or consists of one or more branched polysaccharide.

In another aspect, the present invention provides a method for preparing a foaming ingredient, comprising the steps of:
(a) providing an aqueous mixture comprising carbohydrate, wherein the carbohydrate comprises or consists of one or more branched polysaccharide;
(b) spray-drying the aqueous mixture to provide a porous powder; and
(c) gas-loading the porous powder to provide a foaming ingredient comprising entrapped gas.

The one or more branched polysaccharide may have a degree of branching of about 20% or more, about 25% or more, about 30% or more, about 35% or more, about 40% or more, about 45% or more, or about 50% or more. Suitably, the degree of branching is determined by glycosyl-linkage analysis. The one or more branched polysaccharide may have a conformation slope of about 0.49 or less, about 0.48 or less, about 0.47 or less, about 0.46 or less, about 0.45 or less, about 0.44 or less, or about 0.43 or less. Suitably, the conformation slope is determined by triple detection size exclusion chromatography (SEC) in 0.1 M NaNO₃. The one or more branched polysaccharide may have a Mark-Houwink-Sakurada (MHS) slope of about 0.40 or less, about 0.39 or less, about 0.38 or less, about 0.37 or less, or about 0.36 or less. Suitably, the MHS slope is determined by triple detection SEC in 0.1 M NaNO₃. The one or more branched polysaccharide may have a molecular mass of about 1 kDa or more.

Any suitable branched polysaccharide may be used in any suitable amount. Suitably, the one or more branched polysaccharide comprises or consists of one or more branched dextrin, one or more polydextrose, one or more arabinogalactan, or any combination thereof. In some embodiments, the one or more branched polysaccharide comprises or consists of one or more branched dextrin, or one or more arabinogalactan, or any combination thereof. In some embodiments, the one or more branched polysaccharide comprises or consists of one or more branched dextrin. In some embodiments, the one or more branched polysaccharide comprises or consists of one or more arabinogalactan. Suitably, the foaming ingredient comprises the one or more branched polysaccharide in a total amount of from about 50 wt % to about 90 wt %, from about 55 wt % to about 90 wt %, or from about 60 wt % to about 90 wt %. Suitably, the aqueous mixture comprises the one or more branched polysaccharide in a total amount of from about 50 wt % to about 90 wt %, from about 55 wt % to about 90 wt %, or from about 60 wt % to about 90 wt %, on a dry weight basis.

The foaming ingredient (and aqueous mixture) may comprise one or more emulsifier in any suitable amount. The one or more emulsifier may comprise or consist of protein. Suitably, the protein comprises or consists of milk protein, plant protein, egg protein, or any combination thereof. In some embodiments, the protein comprises or consists of milk protein, optionally wherein the milk protein comprises or consists of one or more caseinate. In some embodiments, the protein comprises or consists of plant protein, optionally wherein the plant protein comprises or consists of pea protein, fava bean protein, chick pea protein, lentil protein, potato protein, wheat protein, soy protein, canola protein, rice protein, hemp protein, or any combination thereof. Suitably, the foaming ingredient comprises one or more emulsifier in an amount of from about 5 wt % to about 30 wt %, from about 5 wt % to about 25 wt %, from about 5 wt % to about 20 wt %, or from about 5 wt % to about 15 wt %. Suitably, the aqueous mixture comprises protein in an amount of from about 5 wt % to about 30 wt %, from about 5 wt % to about 25 wt %, from about 5 wt % to about 20 wt %, or from about 5 wt % to about 15 wt %, on a dry weight basis

The foaming ingredient (and aqueous mixture) may comprise one or more plasticizer in any suitable amount. Suitably, the one or more plasticizer comprises or consists of one or more maltodextrin, one or more glucose syrup, one or more monosaccharide (e.g. glucose, fructose, galactose), one or more disaccharide (e.g. sucrose, lactose, maltose), glycerol, one or more salt, one or more polyol, or any combination thereof. In some embodiments, the one or more plasticizer comprises or consists of sucrose. Suitably, the foaming ingredient comprises one or more plasticizer in an amount such that the glass-transition temperature (T_{g}) of the foaming ingredient is from about 65 °C to about 110 °C (for example from about 65 °C to about 80 °C). Suitably, the foaming ingredient comprises one or more plasticizer in an amount of from about 1 wt % to about 50 wt %, from about 2 wt % to about 50 wt %, from about 5 wt % to about 50 wt %, or from about 10 wt % to about 50 wt %. Suitably, the aqueous mixture comprises one or more plasticizer in an amount such that the glass-transition temperature (T_{g}) of the foaming ingredient is from about 65 °C to about 110 °C (for example from about 65 °C to about 80 °C). Suitably, the aqueous mixture comprises one or more plasticizer in an amount of from about 1 wt % to about 50 wt %, from about 2 wt % to about 50 wt %, from about 5 wt % to about 50 wt %, or from about 10 wt % to about 50 wt %, on a dry weight basis.

The method of the present invention may be carried out using any suitable steps or conditions. Suitably, the aqueous mixture is mixed with a high shear mixer. Suitably, the aqueous mixture, or at least part thereof, is homogenised. Suitably, the aqueous mixture is pasteurised. Suitably, prior to spray-drying the aqueous mixture has a viscosity of from about 50 mPa·s to about 100 mPa·s at a temperature of 60 °C and a shear rate of 100 s⁻¹. Suitably, prior to spray-drying the aqueous mixture has a total solids (TS) of about 35% or more, about 40% or more, about 45% or more, or about 50% or more. Suitably, the gas loaded into the porous powder comprises or consists of nitrogen, air, carbon dioxide, argon, or any combination thereof. In some embodiments, the gas loaded into the porous powder is nitrogen. Suitably, during gas-loading the porous powder is subjected to a pressure of from about 10 bar to about 200 bar, from about 20 bar to about 100 bar, or from about 35 bar to about 55 bar; and a temperature of from about 10 °C to about 30 °C above the glass transition temperature of the porous powder, or from about 15 °C to about 25 °C above the glass transition temperature of the porous powder. Suitably, the porous powder is subsequently cooled below its glass transition temperature and depressurised.

The foaming ingredient may be provided in any suitable form. The foaming ingredient may be in the form of a porous soluble powder. Suitably, the foaming ingredient is in the form of a powder having a particle size distribution D_{3,2} from about 10 μm to about 500 μm.

The foaming ingredient may have a free volume of about 37×10⁻³⁰ m³ or less, about 36×10⁻³⁰ m³ or less, about 35×10⁻³⁰ m³ or less, about 34×10⁻³⁰ m³ or less, or about 33×10⁻³⁰ m³ or less. Suitably, the free volume is determined by positron annihilation lifetime spectroscopy (PALS). The foaming ingredient may have a glass-transition temperature (T_{g}) of from about 65 °C to about 110 °C, from about 65 °C to about 105 °C, from about 65 °C to about 100 °C, from about 65 °C to about 80 °C, from about 70 °C to about 95 °C, from about 70 °C to about 90 °C, or from about 75 °C to about 85 °C. Suitably, the glass-transition temperature (T_{g}) is determined by differential scanning calorimetry (DSC). The foaming ingredient may have a closed porosity of from about 20% to about 80%, from about 30% to about 70%, from about 40% to about 60%, from about 45% to about 55%, from about 46% to about 53%, or from about 47% to about 51%. The foaming ingredient may have a moisture content of from about 0.5% to about 6%, from about 1% to about 5%, from about 2% to about 4%, or from about 2.5% to about 3.0%. The foaming ingredient may have a water activity of from about 0.02 to about 0.20, from about 0.06 to about 0.16, from about 0.09 to about 0.13, or about 0.11.

The entrapped gas may be present in an amount of about 6.0 ml/g or more, about 6.5 ml/g or more, about 7.0 ml/g or more, about 7.5 ml/g or more, or about 8.0 ml/g or more. The foaming ingredient may lose less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15% of the entrapped gas at room temperature over a period of 12 months. The foaming ingredient may generate a foam volume of about 8 cm³/g or more, about 9 cm³/g or more, or about 10 cm³/g or more, when reconstituted in liquid. About 60% or more, about 65% or more, about 70% or more, or about 75% or more of the foam volume may be retained 5 minutes after the foam generation.

In another aspect, the present invention provides a foaming ingredient obtained or obtainable by the method of the present invention.

In another aspect, the present invention provides a soluble beverage powder comprising a foaming ingredient according to the present invention or a foaming ingredient obtained or obtainable by the method of the present invention. The soluble beverage powder may be a creamer or a foamer.

In another aspect, the present invention provides a foaming beverage or foodstuff comprising a foaming ingredient according to the present invention, a foaming ingredient obtained or obtainable by the method of the present invention, or a soluble beverage powder according to the present invention.

In another aspect, the present invention provides use of a foaming ingredient according to the present invention, a foaming ingredient obtained or obtainable by the method of the present invention, or a soluble beverage powder according to the present invention to prepare a foaming beverage or foodstuff.

The foaming beverage or foodstuff may be selected from cappuccino-type beverages, milkshakes, instant chocolate drinks, instant tea, soups, sauces, and desserts.

### DESCRIPTION OF DRAWINGS

FIG. 1—free volume and glass transition temperature (Tg) of foaming ingredients

(A) Free volume of foaming ingredient comprising either glucose syrup DE21 or Nutriose FM10 as the main matrix, with varying sucrose content (from 0 to 30% as a ratio between sucrose and total carbohydrate content) and at a fixed pea protein concentration of 6 wt %. (B) Free volume of foaming ingredient comprising main matrix 84 wt %, sucrose 9 wt % and pea protein 6 wt %. The main matrix was: glucose syrup DE21 (a linear polymer); Nutriose FM10, Fibersol 2 or Promitor 70 (branched dextrins); or Fibergum B or Instantgum AA (acacia gums).

FIG. 2—Schematic representation of IGL and GLK determination methods

(A) Schematic representation of method of determining initial gas loading (IGL). (B) Schematic representation of method of determining gas loss kinetics (GLK).

### DETAILED DESCRIPTION

Various preferred features and embodiments of the present invention will now be described by way of non-limiting examples. This disclosure is not limited by the exemplary methods and materials disclosed herein, and any methods and materials similar or equivalent to those described herein can be used in the practice or testing of embodiments of this disclosure. The skilled person will understand that they can combine all features of the invention disclosed herein without departing from the scope of the invention as disclosed.

It must be noted that as used herein and in the appended claims, the singular forms “a”, “an”, and “the” include plural referents unless the context clearly dictates otherwise.

The terms “comprising”, “comprises” and “comprised of” as used herein are synonymous with “including”, “includes”, “containing”, or “contains”, and are inclusive or open-ended and do not exclude additional, non-recited members, elements or steps. The terms “comprising”, “comprises” and “comprised of” also include the term “consisting of”.

Numeric ranges are inclusive of the numbers defining the range. As used herein the term “about” means approximately, in the region of, roughly, or around. When the term “about” is used in conjunction with a numerical value or range, it modifies that value or range by extending the boundaries above and below the numerical value(s) set forth. In general, the terms “about” and “approximately” are used herein to modify a numerical value(s) above and below the stated value(s) by 10%.

Unless otherwise indicated, wt % is weight percentage on a dry mass basis.

The publications discussed herein are provided solely for their disclosure prior to the filing date of the present application. Nothing herein is to be construed as an admission that such publications constitute prior art to the claims appended hereto.

All publications mentioned in the specification are herein incorporated by reference.

### Foaming Ingredient

In one aspect, the present invention provides a foaming ingredient comprising one or more branched polysaccharide.

As used herein, a “foaming ingredient” (also known as a “foam booster” or “foaming aid”) may refer to an agent that is capable of generating a foam, for example when added to a liquid (e.g. an aqueous solution or water). A foaming ingredient may be capable of generating a foam without the application of mechanical energy such as whipping. The foaming ingredient of the present invention may be suitable for producing enhanced foam in foodstuffs and beverages.

The foaming ingredient of the present invention may be a soluble foaming ingredient. As used herein a “soluble” foaming ingredient may refer to a foaming ingredient being soluble in water. The foaming ingredient may, for example, have a solubility of at least about 20 g/100 mL water at 25 °C.

The foaming ingredient of the present invention may be a porous foaming ingredient. As used herein, a “porous” soluble foaming ingredient may have closed and open pores. The term “open pores” may be used to define voids present in the particles having a connection to the surface of the particle. The term “closed pores” may be used to define completely closed voids. Thus, liquids such as water may not penetrate into the closed pores before the particle dissolves.

The foaming ingredient of the present invention may be a porous soluble foaming ingredient

### Branched Polysaccharide

The foaming ingredient of the present invention comprises one or more branched polysaccharide.

Polysaccharides (also known as polycarbohydrates) are long chain polymeric carbohydrates composed of monosaccharide units bound together by glycosidic linkages, that range in structure from linear to highly branched. As used herein, a “polysaccharide” may refer to any carbohydrate polymer with degree of polymerisation (DP) of 5 or more, 6 or more, 7 or more, 8 or more, 9 or more, 10 or more, 11 or more, or 12 or more. The degree of polymerisation may be determined by SEC-MALS.

As used herein, a “branched polysaccharide” may refer to a polysaccharide having a greater degree of branching than glucose syrup. Glucose syrups are obtained by partial hydrolysis of starch and typically consist of substantially linear polysaccharides having about 95% 1,4-glycosidic linkages and only about 5% 1,6-gluglycosidic linkages. The one or more branched polysaccharide may have a molecular weight of about 1 kDa or more, 1.5 kDa or more, or 2 kDa or more.

Any suitable method may be used to determine that a polysaccharide is a branched polysaccharide, such as glycosyl-linkage analysis, conformation plots, Mark-Houwink-Sakurada plots, or any other suitable method known to the skilled person (e.g. branching ratios).

Exemplary branched polysaccharides include branched dextrins, which can be obtained by heat treatment of starch under acidic conditions, and polydextroses, which can be obtained by the condensation of dextrose under acidic conditions. Exemplary branched polysaccharides also include arabinogalactans, which are high molecular weight polysaccharides, naturally present in coffee and several plants. Other naturally occurring branched polysaccharides such as galactomannans are also available. In some embodiments, the one or more branched polysaccharide comprises or consists of one or more branched dextrin, one or more polydextrose, one or more arabinogalactan, or any combination thereof.

The foaming ingredient of the present invention may comprise the one or more branched polysaccharide in any suitable amount. Suitably, the foaming ingredient comprises the one or more branched polysaccharide in a total amount of about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, or about 75 wt % or more. Suitably, the foaming ingredient comprises the one or more branched polysaccharide in a total amount of about 95 wt % or less, about 90 wt % or less, about 85 wt %, or about 80 wt % or less. Suitably, the foaming ingredient comprises the one or more branched polysaccharide in a total amount of from about 50 wt % to about 90 wt %, from about 55 wt % to about 90 wt %, or from about 60 wt % to about 90 wt %.

The carbohydrate present in the foaming ingredient may comprise the one or more branched polysaccharide and one or more further carbohydrates (e.g. one of more plasticizer, such as sucrose or maltodextrin). The carbohydrate present in the foaming ingredient may essentially consist of the one or more branched polysaccharide (e.g. other carbohydrates may be present, but in amounts such that they can be considered negligible). The carbohydrate present in the foaming ingredient may consist of the one or more branched polysaccharide (e.g. other carbohydrates are not present).

### Degree of Branching

The one or more branched polysaccharide may have a degree of branching of about 20% or more.

Suitably, the one or more branched polysaccharide has a degree of branching of about 20% or more, about 25% or more, about 30% or more, about 35% or more, about 40% or more, about 45% or more, about 50% or more, about 55% or more, or about 60% or more. Suitably, the one or more branched polysaccharide has a degree of branching of about 90% or less, about 85% or less, or about 80% or less. Suitably, the one or more branched polysaccharide has a degree of branching of from about 20% to about 80%, from about 25% to about 80%, from about 30% to about 80%, from about 35% to about 80%, from about 40% to about 80%, from about 45% to about 80%, or from about 50% to about 80%.

The “degree of branching” may be determined by glycosyl-linkage analysis. Suitable methods to perform glycosyl-linkage analysis will be known to the skilled person (see e.g. Sims, I. M., et al., 2018. Carbohydrate Polymers, 188, pp. 1-7). Glycosyl linkage analysis usually involves derivatisation of the individual component sugars of a polysaccharide to partially methylated alditol acetates (PMAAs) which are then analysed and quantified by gas chromatography-mass spectrometry. The linkage positions for each component sugar can be determined by correctly identifying the partially methylated alditol acetates.

The degree of branching may be calculated by the method described in Hölter, D., Burgath, A. and Frey, H., 1997. Acta polymerica, 48(1-2), pp. 30-35. For example, the degree of branching may be determined as 2D/(2D+L), where D is the number of dendritic units or branched units having three or more glycosidic linkages and L is the number of linear units having two glycosidic linkages. For example, the degree of branching in branched dextrins may be determined as 2D/(2D+L), where D is the number of dendritic units or branched units linked at three or more sites (e.g. having at least one 1,2 glycosidic linkage, 1,3 glycosidic linkage, or 1,6 glycosidic linkage) and L is the number of linear units having two glycosidic linkages (e.g. having only 1,4 glycosidic linkages), respectively. For example, the degree of branching in acacia gum may be determined as 2D/(2D+L), where D is the number of dendritic units or branched units linked at three or more sites (e.g. 1->3.4Galp) and L is the number of linear units having two glycosidic linkages (e.g. 1->3 Galp), respectively (see e.g. Lopez-Torrez, L., et al., 2015. Food Hydrocolloids, 51, pp. 41-53).

### Conformation Slope

The one or more branched polysaccharide may have a conformation slope of about 0.49 or less.

Suitably, the one or more branched polysaccharide has a conformation slope of about 0.49 or less, about 0.48 or less, about 0.47 or less, about 0.46 or less, about 0.45 or less, about 0.44 or less, or about 0.43 or less. Suitably, the one or more branched polysaccharide has a conformation slope of about 0.35 or more, about 0.36 or more, about 0.37 or more, about 0.38 or more, about 0.39 or more, or about 0.40 or more. Suitably, the one or more branched polysaccharide has a conformation slope of from about 0.35 to about 0.49, from about 0.35 to about 0.48, from about 0.35 to about 0.47, from about 0.35 to about 0.46, from about 0.35 to about 0.45, from about 0.35 to about 0.44, or from about 0.35 to about 0.43.

The “conformation slope” may be calculated using conformation plots (radius of gyration, Rg versus molar mass, M). The conformation slope may be determined by triple detection size exclusion chromatography (SEC). As used herein, “triple detection SEC” may refer to SEC with online multi-angle light scattering, viscosimeter, and refractometer (SEC-MALS-VI-RI) (see e.g. Saunders, G. A. and Maccreath, B., 2012. Guide to multi-detector gel permeation chromatography. Agilent Technologies, Inc). The conformation slope may be determined in a 0.1 M NaNO₃ solution, optionally at 30 °C. The conformation slope may be determined as described in the examples.

### Mark-Houwink-Sakurada (MHS) Slope

The one or more branched polysaccharide may have a MHS slope of about 0.48 or less.

Suitably, the one or more branched polysaccharide has a MHS slope of about 0.48 or less, about 0.47 or less, about 0.46 or less, about 0.45 or less, about 0.44 or less, about 0.43 or less, about 0.42 or less, about 0.41 or less, about 0.40 or less, about 0.39 or less, about 0.38 or less, about 0.37 or less, about 0.36 or less, about 0.35 or less, about 0.34 or less, about 0.33 or less, about 0.32 or less, about 0.31 or less, or about 0.30 or less. Suitably, the one or more branched polysaccharide has a MHS slope of about 0.10 or more, about 0.15 or more, or about 0.20 or more. Suitably, the one or more branched polysaccharide has a MHS slope of from about 0.10 to about 0.40, from about 0.10 to about 0.39, from about 0.10 to about 0.38, from about 0.10 to about 0.37, from about 0.10 to about 0.36, from about 0.10 to about 0.35, from about 0.10 to about 0.34, from about 0.10 to about 0.33, from about 0.10 to about 0.32, from about 0.10 to about 0.31, or from about 0.10 to about 0.30.

The “MHS slope” may be calculated using MHS plots (intrinsic viscosity, [η] versus molar mass, M). The MHS slope may be determined by triple detection size exclusion chromatography (SEC). The conformation slope may be determined in a 0.1 M NaNO₃ solution, optionally at 30 °C. The conformation slope may be determined as described in the examples.

### Branching Ratio

The one or more branched polysaccharide may have a branching ratio, g′, of about 0.90 or less.

Suitably, the one or more branched polysaccharide has a branching ratio, g′, of about 0.90 or less, about 0.89 or less, about 0.88 or less, about 0.87 or less, about 0.86 or less, about 0.85 or less, about 0.84 or less, about 0.83 or less, about 0.82 or less, about 0.81 or less, or about 0.80 or less. Suitably, the one or more branched polysaccharide has a branching ratio, g′, of about 0.60 or more, 0.61 or more, 0.62 or more, 0.63 or more, 0.64 or more, 0.65 or more, 0.66 or more, 0.67 or more, 0.68 or more, 0.69 or more, or 0.70 or more. Suitably, the one or more branched polysaccharide has a branching ratio, g′, of from about 0.60 to about 0.90, from about 0.60 to about 0.89, from about 0.60 to about 0.88, from about 0.60 to about 0.87, from about 0.60 to about 0.86, from about 0.60 to about 0.85, from about 0.60 to about 0.84, from about 0.60 to about 0.83, from about 0.60 to about 0.82, from about 0.60 to about 0.81, or from about 0.60 to about 0.80.

The “branching ratio” (g′) may be determined by method described in Zimm, B. H. and Kilb, R. W., 1959. Journal of Polymer Science, 37(131), pp. 19-42. For example, using the following equation:

$${g}^{′} = {( \frac{{[ η ]}_{branched}}{{[ η ]}_{linear}} )}_{M} ,$$

where [η] is the intrinsic viscosity of branched and linear polymer molecules having the same molar mass (M). Any suitable linear polymer may be used as the reference, for example for branched dextrin, dextrans may be used as a linear polymer. The branching ratio may be determined by triple detection size exclusion chromatography (SEC). The c branching ratio may be determined in a 0.1 M NaNO₃ solution, optionally at 30 °C. The branching ratio may be determined as described in the examples.

### Branched Dextrin

In some embodiments, the one or more branched polysaccharide comprises or consists of one or more branched dextrin.

As used herein, a “branched dextrin” may also be known as “resistant dextrin” and may refer to a soluble fibre, derived from starch that is prepared by a controlled dextrinization process. During dextrinization, starch is degraded under the action of acid and heat followed by repolymerization. New bonds, including β-1,6, β-1,2, α-1,6, and α-1,2 bonds, may be formed. Exemplary commercially-available branched dextrins include Nutriose (available from Roquette), Fibersol-2 (available from Archer Daniels Midland Company) and Promitor SCF (available from Tate & Lyle) (see e.g. Wlodarczyk, M. and Śliżewska, K., 2021. Nutrients, 13(11), p. 3808).

In some embodiments, the one or more branched polysaccharide comprises or consists of Nutriose (e.g. Nutriose FM06, Nutriose FM10, and/or Nutriose FM15S). Nutriose can be made from either wheat starch (Nutriose FB range) or maize starch (Nutriose FM range), using a highly controlled process of dextrinization. Nutriose may have about 32% 1,6 glycosidic linkages, about 13% 1,2 glycosidic linkages and about 14% 1,3 glycosidic linkages (see Lefranc-Millot, C., 2008. Nutrition Bulletin, 33(3), pp. 234-239 and U.S. Pat. No. 6,630,586).

In some embodiments, the one or more branched polysaccharide comprises or consists of Fibersol-2. Fibersol-2 is produced through a series of controlled enzymatic hydrolysis reactions of cornstarch molecules. This results in cornstarch molecules whose normal alpha-1,4-linkages are replaced with alpha and beta 1,2-, 1,3-, 1,4-, and 1,6-linkages, making it resistant to digestion. It is available as a tasteless, water-soluble, non-viscous powder or liquid that can be added to food and drinks (see e.g. Chen, S. and Martirosyan, D., 2021. Bioactive Compounds in Health and Disease, 4(5), pp. 79-89; U.S. Pat. Nos. 5,620,873 and 5,358,729).

In some embodiments, the one or more branched polysaccharide comprises or consists of Promitor SCF (e.g. Promitor SCF 90, Promitor SCF 85, and/or Promitor SCF 70). Promitor products are produced through the enzymatic hydrolysis of corn starch. Promitor Soluble Gluco Fibre (SCF) contains a mixture of α 1-6, α 1-4, and α 1-2 glucosidic linkages that contribute to the low digestibility of the ingredient (see e.g. Adam-Perrot, A., et al., 2009. Resistant starch and starch-derived oligosaccharides as prebiotics. Prebiotics and Probiotics Science and Technology, pp. 259-291).

### Polydextrose

In some embodiments, the one or more branched polysaccharide comprises or consists of one or more polydextrose.

As used herein, a “polydextrose” may refer to a polysaccharide composed of randomly bonded glucose polymers that is prepared by the bulk melt polycondensation of glucose and sorbitol with small amounts of food grade acid. All possible glycosidic linkages with the anomeric carbon of glucose are present: α and β 1,2, 1,3, 1,4 and 1,6. (see e.g. Flood, M. T., Auerbach, M. H. and Craig, S. A. S., 2004. Food and chemical toxicology, 42(9), pp. 1531-1542). Exemplary commercially-available polydextroses include Sta-Lite polydextrose (available from Tate & Lyle) and Litesse (available from DuPont Nutrition and Biosciences).

### Arabinogalactans

In some embodiments, the one or more branched polysaccharide comprises or consists of one or more arabinogalactan.

As used herein, an “Arabinogalactan” may refer to a biopolymer consisting of arabinose and galactose monosaccharides. In plants, arabinogalactan is a major component of many gums, including gum arabic and gum ghatti.

In some embodiments, the one or more branched polysaccharide comprises or consists of one or more acacia gum. Acacia gum (also called gum Arabic) is a natural arabinogalactan-protein type polysaccharide widely used in industrial applications and may refer to the air-dried exudation from branches and stem of Acacia Senegal Willdenow trees or closely related species such as Acacia seyal. Acacia gum is mainly composed by D-galactose, Larabinose, L-rhamnose, D-glucuronic acid, and 4-O-methyl-D-glucuronic acid with a small fraction of proteins. (see e.g. Lopez-Torrez, L., et al., 2015. Food Hydrocolloids, 51, pp. 41-53).

In some embodiments, the one or more branched polysaccharide comprises or consists of Acacia Senegal and/or Acacia seyal. In some embodiments, the one or more branched polysaccharide comprises or consists of Acacia Senegal. Exemplary commercially-available Acacia Senegal includes InstantGum AA (available from Nexira). In some embodiments, the one or more branched polysaccharide comprises or consists of Acacia seyal. Exemplary commercially-available Acacia seyal include FiberGum B (available from Nexira).

### Entrapped Gas

The foaming ingredient of the present invention comprises gas entrapped in its matrix.

The gas may be any suitable food grade gas. For example, the gas may be nitrogen, carbon dioxide or air, or a mixture of one or more of these gases. Gases which are inert or substantially inert are preferred. Suitably, the entrapped gas comprises or consists of nitrogen, carbon dioxide, air, or any combination thereof. In some embodiments, the gas comprises or consists of nitrogen.

The gas may be entrapped under pressure inside closed pores within the foaming ingredient. The gas may be entrapped at above atmospheric pressure (e.g. above about 101.3 kPa).

The entrapped gas may be present in the foaming ingredient in any suitable amount. Suitably, the entrapped gas is present in amount of about 1.0 ml/g or more, about 2.0 ml/g or more, about 3.0 ml/g or more, about 4.0 ml/g or more, about 5.0 ml/g or more, about 6.0 ml/g or more, about 6.5 ml/g or more, about 7.0 ml/g or more, about 7.5 ml/g or more, or about 8.0 ml/g or more. Suitably, the entrapped gas is present in amount of about 12.0 ml/g or less, about 11.0 ml/g or less, or about 10.0 ml/g or less. Suitably, the entrapped gas is present in an amount of from about 6.0 ml/g to about 12.0 ml/g, from about 6.5 ml/g to about 12.0 ml/g, from about 7.0 ml/g to about 12.0 ml/g, from about 7.5 ml/g to about 12.0 ml/g, or from about 8.0 ml/g to about 12.0 ml/g.

The amount of entrapped gas present in the foaming ingredient may be determined by any suitable method. For example, it may be determined by the amount of gas released at ambient conditions (e.g. 25 °C and atmospheric pressure) upon reconstitution with a liquid (e.g. 1 g powder in 5 ml water). The amount of entrapped gas may be determined by the method described in the examples.

### Emulsifier

The foaming ingredient may comprise one or more emulsifier.

As used herein, an “emulsifier” may refer to a substance comprising a surface-active component. An emulsifier may stabilize the formation of closed pores in the foaming ingredient and/or maintain the closed pore structure when the foaming ingredient is heated to allow pressurized gas to be charged into the foaming ingredient. Moreover, when the foaming ingredient is reconstituted with a liquid an emulsifier can improve the formation and the stability of the foam generated. Exemplary emulsifiers include protein and low molecular mass emulsifiers.

In some embodiments, no additional emulsifier is required. For example, acacia gum may comprise a small fraction of proteins that act as an emulsifier.

In some embodiments, the one or more emulsifier comprises or consists of protein. The protein may be any suitable food grade protein such as milk protein, plant protein, egg protein, or any combination thereof. The protein may be in any form, for example it may be selected from the group consisting of native protein, protein isolate, protein concentrate, hydrolysed protein, fractionated protein, and combinations of these. In some embodiments, the protein is a protein isolate or a protein concentrate.

In some embodiments, the protein comprises or consists of milk protein. A suitable source of protein is non-fat milk solids. These solids may be provided in dry or liquid form (as skimmed milk). Another suitable source of protein is sweet whey, for example in the form of sweet whey powder. Sweet whey powder usually contains a mixture of lactose and whey protein. In some embodiments, the milk protein comprises or consists of casein and/or whey, and derivatives thereof. In some embodiments, the milk protein comprises or consists of caseinate, acid or rennet casein, native micellar casein, whey protein isolate, or any combination thereof. In some embodiments, the milk protein comprises or consists of one or more caseinate (e.g. sodium caseinate and/or calcium caseinate). In some embodiments, the milk protein comprises or consists of sodium caseinate.

In some embodiments, the protein comprises or consists of plant protein. In some embodiments, the plant protein comprises or consists of pea protein, fava bean protein, chick pea protein, lentil protein, potato protein, wheat protein, soy protein, canola protein, rice protein, hemp protein, or any combination thereof. In some embodiments, the plant protein comprises or consists of pea protein, fava bean protein, chick pea protein, lentil protein, potato protein, canola protein, rice protein, hemp protein, or any combination thereof. In some embodiments, the protein comprises or consists of pea protein.

In some embodiments, the one or more emulsifier comprises or consists of low molecular mass emulsifier. In the context of the present invention, the term “low molecular mass emulsifier” may refer to emulsifiers with a molecular mass below about 1.5 kDa. Low molecular mass emulsifiers include, but are not limited to, monoacylglycerols, diacylglycerols, diacetylated tartaric acid esters of monoglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, succinic acid esters of monoglycerides and diglycerides, lactic acid esters of monoglycerides and diglycerides, lysophospholipids, phospholipids, galactolipids, and sucrose esters of fatty acids. The low molecular mass emulsifiers may be added in the form of an ingredient comprising phospholipids or galactolipids, for example lecithin.

The foaming ingredient of the present invention may comprise one or more emulsifier in any suitable amount. Suitably, the foaming ingredient comprises one or more emulsifier in an amount of at least about 5 wt %, at least about 6 wt %, at least about 7 wt %, at least about 8 wt %, or at least about 9 wt %. Suitably, the foaming ingredient comprises one or more emulsifier in an amount of about 50 wt % or less, about 45 wt % or less, about 40 wt % or less, about 35 wt % or less, about 30 wt % or less, about 25 wt % or less, or about 20 wt % or less. Suitably, the foaming ingredient comprises one or more emulsifier in an amount of from about 5 wt % to about 30 wt %, from about 5 wt % to about 25 wt %, or from about 5 wt % to about 20 wt %, or from about 5 wt % to about 15 wt %.

### Plasticizer

The foaming ingredient may comprise one or more plasticizer.

As used herein, a “plasticizer” may refer to a substance (other than water) that has a lower glass transition temperature (T_{g}) than the branched polysaccharide. The plasticizer may be used to decrease the Tg, for example prior to spray-drying. Exemplary plasticizers include maltodextrin, glucose syrup, monosaccharides, disaccharides, salts and polyols.

In some embodiments, the plasticizer comprises or consists of one or more maltodextrin or one or more glucose syrup. Maltodextrin and glucose syrup are produced from starch by partial hydrolysis and are classified by DE (dextrose equivalent) depending of the degree of hydrolysis. Maltodextrin typically has a DE of from about 3 to about 20 and glucose syrup typically has a DE of from about 20 to about 70. In some embodiments, the plasticizer comprises or consists of one or more glucose syrup, for example glucose syrup having a DE of about 47.

In some embodiments, the plasticizer comprises or consists of one or more monosaccharide. Suitable monosaccharides include glucose, fructose and galactose. In some embodiments, the plasticizer comprises or consists of glucose, fructose, or any combination thereof.

In some embodiments, the plasticizer comprises or consists of one or more disaccharide. A disaccharide is formed when two monosaccharides are joined by glycosidic linkage. Suitable disaccharides include sucrose, lactose, maltose, lactulose, and trehalose. In some embodiments, the plasticizer comprises or consists of sucrose, lactose, maltose, or any combination thereof. In some embodiments, the plasticizer comprises or consists of sucrose.

In some embodiments, the plasticizer comprises or consists of one or more polyol. A polyol is an organic compound containing multiple hydroxyl groups. Suitable polyols include erythritol, maltitol, mannitol, lactitol, sorbitol, inositol, Isomalt, xylitol, glycerol, propylene glycol, threitol, and galactitol. In some embodiments, the plasticizer comprises or consists of glycerol, erythritol, sorbitol, mannitol, xylitol, maltitol, lactitol or isomalt. In some embodiments, the plasticizer comprises or consists of glycerol.

In some embodiments, the plasticizer comprises or consists of one or more salt. Suitable salts include sodium chloride, calcium chloride, potassium chloride, potassium carbonate, and sodium dihydrogen-phosphate.

The foaming ingredient of the present invention may comprise one or more plasticizer in any suitable amount. Suitably, the foaming ingredient comprises one or more plasticizer in an amount of about 2 wt % or more, about 3 wt % or more, about 4 wt % or more, about 5 wt % or more, about 6 wt % or more, about 7 wt % or more, about 8 wt % or more, about 9 wt % or more, or about 10 wt % or more. Suitably, the foaming ingredient comprises one or more plasticizer in an amount of about 50 wt % or less, about 45 wt % or less, about 40 wt % or less, about 35 wt % or less, about 30 wt % or less, about 25 wt % or less, or about 20 wt % or less. Suitably, the foaming ingredient comprises one or more plasticizer in an amount of from about 2 wt % to about 50 wt %, from about 2 wt % to about 40 wt %, from about 2 wt % to about 30 wt %, from about 5 wt % to about 30 wt %, or from about 10 wt % to about 30 wt %.

Suitably, the foaming ingredient comprises one or more plasticizer in an amount such that the glass-transition temperature (T_{g}) of the foaming ingredient is from about 50 °C to about 100 °C, from about 55 °C to about 90 °C, from about 60 °C to about 85 °C, or from about 65 °C to about 80 °C. Models are well known to select the appropriate amount and type of plasticizer to achieve the desired glass transition temperature, e.g. the Gordon-Taylor equation or other models (see e.g. Brostow, W., et al., 2008. Materials Letters, 62(17-18), pp. 3152-3155), combined with literature values of the glass transition temperatures of individual plasticizers.

### Other Components

The foaming ingredient of the present invention may comprise any other suitable components, such as artificial sweeteners, flowing agents, colours, flavours, aromas, and the like.

In some embodiments, the foaming ingredient comprises less than about 0.5 wt % fat, less than about 0.1 wt. % fat, or less than about 0.05 wt. % fat. Fat can tend to reduce the quantity of foam released by the foaming ingredient following reconstitution in a liquid.

Suitably, the foaming ingredient is free from one or more potential food allergens. In some embodiments, the foaming ingredient is free from one or more of celery, cereals containing gluten, crustaceans, eggs, fish, lupin, milk, molluscs, mustard, peanuts, sesame, soybeans and tree nuts. For example, the foaming ingredient may be free from milk, peanuts and soybeans.

Suitably, the foaming ingredient is suitable for persons following a vegan diet. Persons following a vegan diet avoid consuming all animal products, including meat, eggs and dairy products. In some embodiments, the foaming ingredient is free from animal proteins such as dairy proteins and egg proteins. In some embodiments, the foaming ingredient is free from lactose.

### Example Foaming Ingredient Compositions

The foaming ingredient may comprise one or more branched polysaccharide, one or more emulsifier, one or more plasticizer, and entrapped gas.

For example, the foaming ingredient may comprise: one or more branched polysaccharide (e.g. branched dextrin, polydextrose, and/or arabinogalactan) in an amount of from about 50 wt % to about 90 wt %; one or more emulsifier (e.g. protein) in an amount of from about 5 wt % to about 30 wt %; one or more plasticizer (e.g. sucrose) in an amount of from about 1 wt % to about 50 wt %; and entrapped gas in an amount of about 6.0 ml/g or more.

For example, the foaming ingredient may comprise: one or more branched polysaccharide (e.g. branched dextrin, polydextrose, and/or arabinogalactan) in an amount of from about 60 wt % to about 90 wt %; one or more emulsifier (e.g. protein) in an amount of from about 5 wt % to about 15 wt %; one or more plasticizer (e.g. sucrose) in an amount of from about 10 wt % to about 30 wt %%; and entrapped gas in an amount of about 7.0 ml/g or more.

### Foaming Ingredient Structural Parameters

The foaming ingredient may be provided in any suitable form. Typically, the foaming ingredient is provided in a powder form (e.g. in the form of a porous soluble powder). Suitably, the foaming ingredient is in the form of a powder having a particle size distribution D_{3,2} from about 10 μm to about 500 μm. The average particle size D_{3,2} is sometimes called the Sauter mean diameter and may be determined by laser light scattering.

The foaming ingredient may have a free volume of about 40×10⁻³⁰ m³ or less, about 39×10⁻³⁰ m³ or less, about 38×10⁻³⁰ m³ or less, about 37×10⁻³⁰ m³ or less, about 36×10⁻³⁰ m³ or less, about 35×10⁻³⁰ m³ or less, about 34×10⁻³⁰ m³ or less, or about 33×10⁻³⁰ m³ or less. The foaming ingredient may have a free volume of about 25×10⁻³⁰ m³ or more, about 26×10⁻³⁰ m³ or more, about 27×10⁻³⁰ m³ or more, about 28×10⁻³⁰ m³ or more, 29×10⁻³⁰ m³ or more, or 30×10⁻³⁰ m³ or more. The foaming ingredient may have a free volume of from about 25×10⁻³⁰ m³ to about 40×10⁻³⁰ m³, from about 25×10⁻³⁰ m³ to about 39×10⁻³⁰ m³, from about 25×10⁻³⁰ m³ to about 38×10⁻³⁰ m³, from about 25×10⁻³⁰ m³ to about 37×10⁻³⁰ m³, from about 25×10⁻³⁰ m³ to about 36×10⁻³⁰ m³, from about 25×10⁻³⁰ m³ to about 35×10⁻³⁰ m³, from about 25×10⁻³⁰ m³ to about 34×10⁻³⁰ m³, or from about 25×10⁻³⁰ m³ to about 33×10⁻³⁰ m³. Suitably, the free volume is determined by positron annihilation lifetime spectroscopy (PALS) (see e.g. Jean, A. C., 1990. Microchemical Journal, 42(1), pp. 72-102). The free volume may be determined by the method described in the examples.

The foaming ingredient may have a glass transition temperature (T_{g}) of about 50 °C or more, about 55 °C or more, about 60 °C or more, about 65 °C or more, about 70 °C or more, about 75 °C or more, or about 80 °C or more. The foaming ingredient may have a glass transition temperature (T_{g}) of about 110 °C or less, about 105 °C or less, about 100 °C or less, about 95 °C or less, about 90 °C or less, or about 85 °C or less. The foaming ingredient may have a glass transition temperature (T_{g}) of from about 70 °C to about 110 °C, from about 70 °C to about 105 °C, from about 70 °C to about 100 °C, from about 70 °C to about 95 °C, from about 70 °C to about 90 °C, or from about 75 °C to about 85 °C.

As used herein, the term “glass transition temperature” is commonly understood as the temperature at which an amorphous solid becomes soft (rubbery) upon heating or brittle (glassy) upon cooling. The glass transition temperature is always lower than the melting temperature (Tₘ) of the crystalline state of the material. An amorphous material can therefore be conventionally characterised by a glass transition temperature, denoted T_{g}. A material is in the form of a glassy solid when it is below its glass transition temperature. The foaming ingredient of the invention may be a glassy solid. Suitably, the glass-transition temperature (T_{g}) is determined by differential scanning calorimetry (DSC) or dynamic mechanical thermal analysis (DMTA). Suitably, the glass-transition temperature (T_{g}) is determined by DSC. Suitably, the term “about” in relation to glass-transition temperature (T_{g}) may mean ±3 °C. The glass-transition temperature (T_{g}) may be determined by the method described in the examples.

The foaming ingredient may have a closed porosity of about 20% or more, about 25% or more, about 30% or more, about 35% or more, about 40% or more, about 41% or more, about 42% or more, about 43% or more, about 44% or more, about 45% or more, about 46% or more, or about 47% or more. The foaming ingredient may have a closed porosity of about 80% or less, about 75% or less, about 70% or less, about 65% or less, about 60% or less, about 55% or less, about 54% or less, about 53% or less, about 52% or less, or about 51% or less. The foaming ingredient may have a closed porosity of from about 20% to about 80%, from about 30% to about 70%, from about 40% to about 60%, from about 45% to about 55%, from about 46% to about 53%, or from about 47% to about 51%.

Closed porosity may be calculated from the matrix density and the apparent density, according to the following equation:

$$Closed porosity = 100 \cdot ( 1 - \frac{{ρ}_{apparent}}{{ρ}_{matrix}} ) .$$

The matrix density (ρₘₐₜᵣᵢₓ) is the density of the solid material forming the foaming ingredient, sometimes referred to as the “true density”. The matrix density may be determined using a density meter. The apparent density (ρₐₚₚₐᵣₑₙₜ), sometimes called “skeletal density”, is the ratio of the mass of the foaming ingredient to the sum of the foaming ingredient volume including closed pores. The apparent density may be obtained by measuring the volume of a weighed amount of the ingredient using a helium pycnometer. The closed porosity may be determined by the method described in the examples.

Suitably, the foaming ingredient has pores having a size distribution D_{3,2} of from about 0.1 μm to about 40 μm. For the same overall closed porosity, smaller closed pores can lead to a finer foam on dissolution. The pore size distribution may be measured by x-ray tomography, based on the void volume distribution.

The foaming ingredient may have a moisture content of about 6% or less, about 5% or less, about 4% or less, or about 3% or less. The foaming ingredient may have a moisture content of about 0.5% or more, about 1% or more, about 1.5% or more, about 2% or more, or about 2.5% or more. The foaming ingredient may have a moisture content of from about 0.5% to about 6%, from about 1% to about 5%, from about 2% to about 4%, or from about 2.5% to about 3.0%. Suitably, the moisture content is determined by thermo-gravimetry analysis. The moisture content may be determined by the method described in the examples.

The foaming ingredient may have a water activity of about 0.20 or less, about 0.19 or less, about 0.18 or less, about 0.17 or less, about 0.16 or less, about 0.15 or less, about 0.14 or less, about 0.13 or less, about 0.12 or less, or about 0.11 or less. The foaming ingredient may have a water activity of about 0.1 or less. The foaming ingredient may have a water activity of about 0.01 or more, about 0.02 or more, about 0.03 or more, about 0.04 or more, about 0.05 or more, about 0.06 or more, about 0.07 or more, about 0.08 or more, or about 0.09 or more. The foaming ingredient may have a water activity of from about 0.01 to about 0.20, from about 0.06 to about 0.16, from about 0.09 to about 0.13, or about 0.11. The water activity may be determined by a water activity meter. The water activity may be determined by the method described in the examples.

The foaming ingredient may have one or more structural parameters described herein. For example, the foaming ingredient may have a free volume of about 40×10⁻³⁰ m³ or less, a glass transition temperature (Tg) of from about 70 °C to about 110 °C, a closed porosity of from about 20% to about 80%, a moisture content of from about 0.5% to about 6%, and a water activity of from about 0.01 to about 0.20. For example, the foaming ingredient may have a free volume of about 37×10⁻³⁰ m³ or less, a glass transition temperature (Tg) of from about 70 °C to about 110 °C, a closed porosity of from about 47% to about 51%, a moisture content of from about 2.5% to about 3.0%, and a water activity of from about 0.09 to about 0.13.

### Foaming Ingredient Functional Parameters

The foaming ingredient may have improved gas retention. The foaming ingredient may lose about 30% or less, about 29% or less, about 28% or less, about 27% or less, about 26% or less, about 25% or less, about 24% or less, about 23% or less, about 22% or less, about 21% or less, about 20% or less, about 19% or less, about 18% or less, about 17% or less, about 16% or less, or about 15% or less of the entrapped gas at room temperature (e.g. from about 20 °C to about 25 °C) over a period of 12 months. Suitably, the foaming ingredient loses about 5% or more or about 10% or more of the entrapped gas at room temperature (e.g. from about 20 °C to about 25 °C) over a period of 12 months. Suitably, the foaming ingredient loses from about 5% to about 30%, from about 5% to about 25%, or from about 5% to about 20% of the entrapped gas at room temperature (e.g. from about 20 °C to about 25 °C) over a period of 12 months. The gas loss may be determined by sealing the foaming ingredient in a sealed airtight vial and quantifying the gas which accumulates in the headspace and comparing to the initial quantity of entrapped gas. The gas loss may be determined by the method described in the examples.

The foaming ingredient may generate a large foam volume when reconstituted in liquid (e.g. an aqueous solution or water). The foaming ingredient may generate a foam volume of about 5 cm³/g or more, about 6 cm³/g or more, about 7 cm³/g or more, about 8 cm³/g or more, about 9 cm³/g or more, or about 10 cm³/g or more, when reconstituted in liquid (e.g. an aqueous solution or water). Suitably, the foaming ingredient generates a foam volume of about 12 cm³/g or less or about 11 cm³/g or less, when reconstituted in liquid (e.g. an aqueous solution or water). Suitably, the foaming ingredient generates a foam volume of from about 5 cm³/g to about 12 cm³/g, from about 6 cm³/g to about 12 cm³/g, from about 7 cm³/g to about 12 cm³/g, from about 8 cm³/g to about 12 cm³/g, from about 9 cm³/g to about 12 cm³/g, or from about 10 cm³/g to about 12 cm³/g, when reconstituted in liquid (e.g. an aqueous solution or water). The foam volume may be determined by adding 200 mL of water at around 85 °C to between 2 and 10 g of the material in a beaker having a diameter of 6.5 cm and, after 5 seconds, stirring the resulting liquid clockwise 20 times and counter-clockwise 20 times before immediately measuring the foam volume. The foam volume may be determined by the method described in the examples.

The foam generated following reconstitution in liquid may have good stability. Suitably, about 60% or more, about 65% or more, about 70% or more, or about 75% or more of the foam volume may be retained is retained 5 minutes after the foam generation. Suitably, about 90% or less, about 85% or less, or about 80% or less of the foam volume is retained 5 minutes after the foam generation. Suitably, from about 60% to about 90%, from about 60% to about 85%, or from about 60% to about 80% of the foam volume is retained 5 minutes after the foam generation. The foam stability may be determined by the method described in the examples.

The foaming ingredient may have one or more functional parameters described herein. For example, the foaming ingredient may comprise entrapped gas in an amount of about 6.0 ml/g or more, lose less than about 30% of the entrapped gas at room temperature over a period of 12 months, generate a foam volume of about 8 cm³/g or more when reconstituted in liquid, and retain about 60% or more of the foam volume after the foam generation. For example, the foaming ingredient may comprise entrapped gas in an amount of about 7.0 ml/g or more, lose less than about 20% of the entrapped gas at room temperature over a period of 12 months, generate a foam volume of about 10 cm³/g or more when reconstituted in liquid, and retain about 70% or more of the foam volume after the foam generation.

### Method for Preparing a Foaming Ingredient

In one aspect, the present invention provides a method for preparing a foaming ingredient. The foaming ingredient may be any foaming ingredient described herein in the section entitled “Foaming ingredient”.

The method for preparing the foaming ingredient may comprise any suitable steps. For example, the method for preparing the foaming ingredient may comprise the following steps:
(a) providing an aqueous mixture comprising one or more branched polysaccharide;
(b) spray-drying the aqueous mixture to provide a porous powder; and
(c) gas-loading the porous powder to provide a foaming ingredient comprising entrapped gas.

The method of the present invention may comprise any other suitable steps, for example any steps described below or in the examples.

In one aspect, the present invention provides an aqueous mixture for preparing a foaming ingredient, comprising one or more branched polysaccharide. The aqueous mixture may be any described herein.

In one aspect, the present invention provides a porous powder for preparing a foaming ingredient, comprising one or more branched polysaccharide. The porous powder may have the same composition as any foaming ingredient described herein in the section entitled “Foaming ingredient”, but wherein the porous powder embedded gas is at least partly absent or substantially absent.

In one aspect, the present invention provides a foaming ingredient obtained by or obtainable by the method of the present invention. The foaming ingredient may be any foaming ingredient described herein in the section entitled “Foaming ingredient”.

Step (a)—Providing an Aqueous Mixture

The aqueous mixture may be any aqueous mixture suitable for preparing a foaming ingredient according to the present invention and may be prepared by any suitable steps.

The carbohydrate present in the aqueous mixture may comprise the one or more branched polysaccharide and one or more further carbohydrates (e.g. one or more plasticizers). The carbohydrate present in the aqueous mixture may essentially consist of the one or more branched polysaccharide (e.g. other carbohydrates may be present, but in amounts such that they can be considered negligible). The carbohydrate present in the aqueous mixture may consist of the one or more branched polysaccharide (e.g. other carbohydrates are not present).

The one or more branched polysaccharide may be any described herein in the section entitled “Branched polysaccharide”. The aqueous mixture may comprise the one or more branched polysaccharide in any suitable amount. Suitably, the aqueous mixture comprises the one or more branched polysaccharide in a total amount of about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, or about 75 wt % or more, on a dry weight basis. Suitably, the aqueous mixture comprises the one or more branched polysaccharide in a total amount of about 90 wt % or less, about 85 wt %, or about 80 wt % or less, on a dry weight basis. Suitably, the aqueous mixture comprises the one or more branched polysaccharide in a total amount of from about 50 wt % to about 90 wt %, from about 55 wt % to about 90 wt %, or from about 60 wt % to about 90 wt %, on a dry weight basis.

The aqueous mixture may comprise one or more emulsifier. The emulsifier may be any described herein in the section entitled “Emulsifier”. The aqueous mixture may comprise the one or more emulsifier in any suitable amount. The aqueous mixture may comprise the one or more emulsifier in any suitable amount. Suitably, the aqueous mixture comprises the one or more emulsifier in an amount of at least about 5 wt %, at least about 6 wt %, at least about 7 wt %, at least about 8 wt %, or at least about 9 wt %, on a dry weight basis. Suitably, the aqueous mixture comprises the one or more emulsifier in an amount of about 50 wt % or less, about 45 wt % or less, about 40 wt % or less, about 35 wt % or less, about 30 wt % or less, about 25 wt % or less, or about 20 wt % or less, on a dry weight basis. Suitably, the aqueous mixture comprises the one or more emulsifier in an amount of from about 5 wt % to about 30 wt %, from about 5 wt % to about 25 wt %, or from about 5 wt % to about 20 wt %, or from about 5 wt % to about 15 wt %, on a dry weight basis.

The aqueous mixture may comprise one or more plasticizer. The plasticizer may be any described herein in the section entitled “Plasticizer”. The aqueous mixture of the present invention may comprise the one or more plasticizer in any suitable amount. Suitably, the aqueous mixture comprises the one or more plasticizer in an amount of about 2 wt % or more, about 3 wt % or more, about 4 wt % or more, about 5 wt % or more, about 6 wt % or more, about 7 wt % or more, about 8 wt % or more, about 9 wt % or more, or about 10 wt % or more, on a dry weight basis. Suitably, the aqueous mixture comprises the one or more plasticizer in an amount of about 50 wt % or less, about 45 wt % or less, about 40 wt % or less, about 35 wt % or less, about 30 wt % or less, about 25 wt % or less, or about 20 wt % or less %, on a dry weight basis. Suitably, the aqueous mixture comprises the one or more plasticizer in an amount of from about 2 wt % to about 50 wt %, from about 2 wt % to about 40 wt %, from about 2 wt % to about 30 wt %, from about 5 wt % to about 30 wt %, or from about 10 wt % to about 30 wt %, on a dry weight basis. Suitably, the aqueous mixture comprises the one or more plasticize in an amount such that the glass-transition temperature (T_{g}) of the foaming ingredient is from about 50 °C to about 100 °C, from about 55 °C to about 90 °C, from about 60 °C to about 85 °C, or from about 65 °C to about 80 °C.

The aqueous mixture may comprise one or more branched polysaccharide, one or more emulsifier, and one or more plasticizer. For example, the aqueous mixture may comprise: one or more branched polysaccharide (e.g. branched dextrin, polydextrose, and/or arabinogalactan) in an amount of from about 50 wt % to about 90 wt % on a dry weight basis; one or more emulsifier (e.g. protein) in an amount of from about 5 wt % to about 30 wt % on a dry weight basis; and one or more plasticizer (e.g. sucrose) in an amount of from about 1 wt % to about 50 wt % on a dry weight basis. For example, the aqueous mixture may comprise: one or more branched polysaccharide (e.g. branched dextrin, polydextrose, and/or arabinogalactan) in an amount of from about 60 wt % to about 90 wt % on a dry weight basis; one or more emulsifier (e.g. protein) in an amount of from about 5 wt % to about 15 wt % on a dry weight basis; and one or more plasticizer (e.g. sucrose) in an amount of from about 10 wt % to about 30 wt % on a dry weight basis.

The step of providing the aqueous mixture may include any other suitable processing steps.

Suitably, the aqueous mixture is mixed with a high shear mixer. A high shear mixer may be used to disperse one phase or ingredient (e.g. liquid, solid, gas) into a main continuous phase (e.g. liquid), with which it would normally be immiscible.

Suitably, the aqueous mixture, or at least part thereof, is homogenised. Homogenisation may be used to ensure that the components are uniformly distributed throughout the aqueous mixture. Suitably, the homogenisation is carried out at about 200 bars/50 bars. In some embodiments, the homogenization is performed by a high pressure homogenizer, for example where a fluid is forced to pass through a small hole by applying high pressure. In some embodiments, the emulsifier (e.g. plant protein) is homogenised. Homogenization of e.g. plant proteins in an aqueous mixture can increase their solubility and their foaming performance. The plant proteins may be homogenized in the presence of carbohydrates (e.g. the one or more branched polysaccharide) or the carbohydrates (e.g. the one or more branched polysaccharide) may be added after homogenization.

Suitably, the aqueous mixture is pasteurised. Pasteurisation may refer to treatment with mild heat, usually to less than 100 °C, to partially sterilize the aqueous mixture. Suitably, pasteurisation is carried out at about 75 °C for about 5 minutes.

Step (b)—Spray-Drying the Aqueous Mixture

The aqueous mixture may be dried by any suitable method. Suitably, the aqueous mixture is spray-dried to provide a porous powder.

Any suitable steps may be used to prepare the aqueous mixture for spray-drying.

Suitably, prior to spray-drying the aqueous mixture has a viscosity of form about 30 mPa·s to about 200 mPa·s, from about 40 mPa·s to about 150 mPa·s, or from about 50 mPa·s to about 100 mPa·s, at a temperature of 60 °C and a shear rate of 100 s⁻¹. The viscosity of the aqueous mixture may be adjusted by any suitable method (e.g. heating of the aqueous mixture to from about 50 to about 70 °C or about 60 °C).

Suitably, prior to spray-drying the aqueous mixture has a total solids (TS) of about 35% or more, about 40% or more, about 45% or more, or about 50% or more. Suitably, prior to spray-drying the aqueous mixture has a total solids (TS) of about 70% or less, 65% or less, or 60% or less. Suitably, prior to spray-drying the aqueous mixture has a total solids (TS) of from about 35% to about 70%, from about 40% to about 70%, from about 45% to about 70%, or from about 50% to about 70%.

Suitably, gas is dissolved in the aqueous mixture before spray drying. Gas dissolved in the aqueous mixture during spray drying can serve to form the initial porous structure. The gas dissolved in the aqueous mixture may be any suitable food grade gas described herein in the section entitled “Entrapped gas”. The aqueous mixture comprising dissolved gas may be held under high pressure up to the point of spraying. For example, the gas may be nitrogen and it may be added for as long as it takes to achieve full dissolution of gas in the said mixture. For example, the time to reach full dissolution may be at least about 2 minutes, at least about 4 minutes, at least about 10 minutes, for at least about 20 minutes, or at least about 30 minutes.

Any suitable spray-drying conditions and apparatus may be used. Suitably, the spraying pressure is from about 100 bars to about 150 bars, from about 110 bars to about 140 bars, or from about 120 bars to about 130 bars. Suitably, the injection pressure is about 1 bar to about 5 bars, from about 1 bar to about 3 bars, or about 2 bars above the spraying pressure. Suitably, the nozzle diameter is from about 0.1 mm to about 0.4 mm, or from about 0.2 mm to about 0.3 mm.

Step (c)—Gas-Loading the Porous Powder

The porous powder may be loaded with gas by any suitable method.

For example, introducing gas into the foaming ingredient may be performed by heating the porous powder having a glassy continuous phase to a temperature above its glass transition temperature and then subjecting the porous powder to a gas under pressure. The pores of the powder are filled with gas under pressure and then the temperature of the powder is reduced to below its glass transition temperature to trap pressurized gas in the pores.

Without wishing to be bound by theory, the gas under pressure is able to fill the closed pores of the porous powder because the matrix material making up the continuous phase of the ingredient is in the rubbery state, being above its glass transition temperature and becoming pervious to gas. Once the foaming ingredient cools, the matrix material becomes glassy and traps the pressurized gas. The external pressure can then be released, leaving the closed pores of the foaming ingredient containing gas under pressure. Alternatively, rapid release of pressure may be used to quench cool the porous powder.

The gas may be loaded into the porous powder by a method comprising: (i) pressurising the porous powder with gas; (ii) heating the porous powder to a temperature above its glass transition temperature; (iii) cooling the porous powder to a temperature below its glass transition temperature; and (iv) depressurising the porous powder.

The gas may be any suitable food grade gas. For example, the gas may be nitrogen, carbon dioxide or air, and mixtures of these gases. Gases which are inert or substantially inert are preferred. Suitably, the entrapped gas comprises or consists of nitrogen, carbon dioxide, air, or any combination thereof. In some embodiments, the gas comprises or consists of nitrogen.

The porous powder may be subjected to a pressure of at least about 10 bar, at least about 15 bar, at least about 20 bar, at least about 25 bar, at least about 30 bar, or at least about 35 bar. Suitably, the porous powder is subjected to a pressure of about 200 bar or less, about 150 bar or less, about 100 bar or less, or about 55 bar or less. Suitably, the porous powder is subjected to a pressure of from about 10 bar to about 200 bar, from about 20 bar to about 100 bar, or from about 35 bar to about 55 bar.

The porous powder may be subjected to a temperature of at least about 5 °C, at least about 10 °C, at least about 15 °C, or at least about 20 °C above the glass transition temperature of the porous powder. Suitably, the porous powder is subjected to a temperature of from about 10 °C to about 30 °C above the glass transition temperature of the porous powder, or from about 15 °C to about 25 °C above the glass transition temperature of the porous powder. The duration of heating at the temperature above the glass transition temperature may be at least about 10 seconds, at least about 20 seconds, at least about 30 seconds, or at least about 1 minute.

The porous powder may be subsequently cooled below its glass transition temperature and depressurised. Suitably, the porous powder is cooled to ambient temperature (e.g. from about 20 °C to about 25 °C). Suitably, the porous powder is depressurised to ambient pressure (e.g. atmospheric pressure).

### Soluble Beverage Powder

In another aspect, the present invention provides a soluble powder comprising a foaming ingredient according to the present invention or a foaming ingredient obtained or obtainable by the method of the present invention.

The soluble powder may comprise the foaming ingredient in any suitable amount. For example, about 5 wt % or more, about 10 wt % or more, or about 15 wt % or more. For example, about 80 wt % or less, about 70 wt % or less, about 60 wt % or less, about 50 wt % or less, about 40 wt % or less, or about 30 wt % or less. For example, from about 5 wt % to about 80 wt %, from about 10 wt % to about 60 wt %, or from about 15 wt % to about 50 wt %.

The soluble powder may be a soluble beverage powder. The soluble beverage powder may be a foamer or a creamer. As used herein, a “foamer” may refer a product that provides a foam upon dissolution. As used herein, a “creamer” may refer to a whitening power that may also provide a foam.

In some embodiments, the soluble powder is a foamer. The foamer ingredient may be used in soluble foamer powders to produce increased amounts of foam when the foamer powder is reconstituted with liquid. Foamers may be used in instant beverages and foodstuffs, in particular soluble beverages, like instant milkshakes and instant cappuccino. In some embodiments, the foamer is a cappuccino foamer.

In some embodiments, the soluble powder is a creamer. Creamers are widely used as whitening agents with hot and cold beverages such as, for example, coffee, cocoa and tea. They are commonly used in place of milk and/or dairy cream. The foaming ingredient may be dry mixed with a creamer component, agglomerated with a creamer component or creamer components may be included in the foaming ingredient so as to prepare a soluble creamer powder.

In some embodiments, the soluble powder is a mix comprising the foaming ingredient, soluble coffee and powdered creamer. In some embodiments, the soluble powder is an instant cappuccino powder mix, for example comprising the foaming ingredient, soluble coffee and a creamer. The instant cappuccino mix may be suitable for persons following a vegan diet.

The soluble powder comprising the foaming ingredient may contain other components such as artificial sweeteners, emulsifiers, stabilisers, flowing agents, colours, flavours, aromas, and the like.

### Foaming Beverage or Foodstuff

The foaming ingredient or soluble powder according to the present invention may be used to prepare a foaming beverage or foodstuff. Examples of such beverages are instant cappuccino, instant chocolate drinks, instant tea and instant milkshake. Examples of non-beverage foodstuffs include soups, sauces and desserts.

In one aspect, the present invention provides a foaming beverage or foodstuff comprising a foaming ingredient according to the present invention, a foaming ingredient obtained or obtainable by the method of the present invention, or a soluble powder according to the present invention.

In one aspect, the present invention provides a food powder comprising the foaming ingredient, for example a powder to be reconstituted as an aerated dessert.

### EXAMPLES

The invention will now be further described by way of examples, which are meant to serve to assist one of ordinary skill in the art in carrying out the invention and are not intended in any way to limit the scope of the invention.

### Example 1—Determination of Structural Parameters of Glucose Syrup Replacements

Glucose syrup has been used as the main matrix in foaming ingredients. It is produced by enzymatic treatment of starch, where maltodextrin=DE<20 and glucose syrup=DE>20, and typically consists of substantially linear polysaccharides.

The following polysaccharides were investigated for use in foaming ingredients as a replacement for glucose syrup:
Branched dextrins—Nutriose and Fibersol are branched dextrins which are produced by enzymatic treatment of starch followed by acid-mediated condensation. Promitor is a branched dextrin which is produced by acid-mediated condensation of corn syrup.
Polydextrose—produced by acid-mediated condensation of dextrose/glucose.
Inulin—linear polysaccharides consisting of β 1-2 linked fructose units.
Arabinogalactans—high molecular weight polysaccharides naturally present in coffee and several plants. A common source of food-grade arabinogalactans are acacia gums.

### Results

The key structural parameters of commercially available glucose syrup replacers were determined and are summarised in the table below. The three branched dextrins each have a high degree of branching, as confirmed by the conformation slope, MHS slope and branching ratio (g′). In contrast, inulin is a linear polysaccharide, as confirmed by the conformation slope and MHS slope. Acacia Seyal and Acacia Senegal are known to have a high degree of branching (approx. 55-80%, see e.g. Lopez-Torrez, L., et al., 2015. Food Hydrocolloids, 51, pp. 41-53).

| | | Mw | | Rh | Conformation | MHS | |
|---|---|---|---|---|---|---|---|
| | Type | (kDa) | PDI | (nm) | slope | slope | g′ |
| Promitor 70 | Branched dextrin | 2.2 | 1.3 | 1.1 | 0.41 | 0.22 | 0.71 |
| Nutriose FM10 | Branched dextrin | 4.5 | 1.5 | 1.4 | 0.43 | 0.27 | 0.81 |
| Fibersol 2 | Branched dextrin | 3.3 | 1.5 | 1.2 | 0.43 | 0.25 | 0.75 |
| Sta-Lite | Polydextrose | 1.6 | 1.29 | 1.0 | 0.40 | 0.202 | ND |
| Fibruline XL | Inulin | 4.9 | 1.09 | 1.6 | 0.50 | 0.495 | ND |
| FiberGum B | Acacia Seyal | 1022 | 1.19 | ND | ND | ND | ND |
| InstantGum AA | Acacia Senegal | 772 | 2.09 | ND | ND | ND | ND |

ND = not determined

### Materials and Methods

The following commercially available polysaccharides were used.

| | Polysaccharide type | Source |
|---|---|---|
| Promitor 70EU | Branched dextrin | Tate & Lyle |
| Nutriose FM10 | Branched dextrin | Roquette |
| Fibersol 2 | Branched dextrin | ADM |
| Sta-Lite | Polydextrose | Tate & Lyle |
| Fibruline XL | Inulin | Cosucra |
| FiberGum B | Acacia Seyal | Nexira |
| InstantGum AA | Acacia Senegal | Nexira |

The different ranges of e.g. Promitor (70, 85 and 90) and Nutriose (FM06, FM10) are produced according to the same process but are more or less purified afterwards to remove small sugars. Therefore the structural analysis of any member of e.g. the Nutriose or Promitor derivatives are the same and results are applicable to the other commercial products.

The molecular weight and the branching of the polysaccharides constituting the booster matrix were characterized by size exclusion chromatography (SEC) using an Agilent 1200 HPLC coupled to three detectors: multi-angle laser light scattering (MALLS) operating at eighteen angles (Dawn Heleos II, Wyatt, CA, USA), on-line viscosimeter (VISCOSTAR II, Wyatt, CA, USA) and differential refractometer (Optilab T-rEX, Wyatt, CA, USA). The system was composed of one Tosoh PWH pre-column followed by three columns in series (Tosoh G6000PW, G3000PW and GP2500).

All samples were prepared in 0.1 M NaNO₃ solution (20-30 mg/mL), filtered through a 0.22 μm filter and eluted through the system with 0.1 M NaNO₃ solution containing 0.05% ProClin 2000 at a constant flow rate of 0.6 mL min⁻¹ and 30 °C in triplicate.

Data were analysed using ASTRA software 7.3.1 (Wyatt Technologies, Santa Barbara, CA). The weight-averaged molecular mass (or molecular weight, Mw), the hydrodynamic radius (defined as the radius of a hard sphere that diffuses at the same rate as that solute, Rh), the intrinsic viscosity (which represents the contribution of a solute to the solution viscosity η, [η]), and the polydispersity index (PDI, Mw/Mn) were calculated using a refractive index increment (dn/dc) of 0.15 mL g⁻¹.

The branching was studied using conformation plots (Rh versus Mw) and Mark-Houwink-Sakurada (MHS) plots ([η] versus Mw). On a conformation plot, a linear polymer in solution adopting a random coil conformation typically presents a slope of 0.6, while a branched polymer shows a lower slope of 0.3-0.5. As a rule of thumb, the lower the slope, the higher the branching. The same rule applies on an MHS plot, with a random coil conformation showing a slope of 0.7 and a branched polymer a slope of 0.1-0.6.

The branching ratio g′ was calculated as described in Zimm, B. H. and Kilb, R. W., 1959. Journal of Polymer Science, 37(131), pp. 19-42:

$${g}^{′} = {( \frac{{[ η ]}_{branched}}{{[ η ]}_{linear}} )}_{M}$$

where [η] is the intrinsic viscosity of branched and linear polymer molecules of same chemical structure having the same molar weight distribution. The higher g′, the lower the branching. Dextrans were used as reference for the linear polymer of identical chemical structure.

### Example 2—Preparation of Foaming Ingredients Comprising Branched Polysaccharides

Foaming ingredients were produced as follows:
A mixture of glucose syrup replacers with sucrose and protein was reconstituted at ambient temperature, mixed with shear mixer. The quantity of plasticizer was adjusted to achieve a final Tg of the foaming ingredient of between 65 °C and 80 °C. When plant proteins were used, there was a step of homogenization (200 bars/50 bars) that allows increasing the solubility of plant proteins from 30%-40% to more than 90%. The aqueous mixture was heated at 75 °C for 5 minutes during the pasteurization.
The temperature of the aqueous mixture was stabilized at 60 °C before spray-drying. Gassing with nitrogen was carried out at 0.5 NL/kg after the high pressure pump. The spraying pressure was 120-130 bars while the injection pressure was 2 bars above the spraying pressure. Typical flowrate was approx. 15 L/h, depending on the nozzle diameter and the solution composition. The high pressure nozzle diameter was 0.2-0.3 mm.
Gas loading of the foaming ingredient was performed in a high pressure reaction. The programme of gas loading was: pressurization at 45 bar; heating up to Tg+21 °C; step of 1 min at Tg+21 °C; cooling down to 20 °C; depressurization at ambient pressure

### Example 3—Characterisation of Foaming Ingredients Comprising Branched Polysaccharides

### Results

The characteristics of foaming ingredients comprising branched polysaccharides (e.g. Nutriose FM10 and InstantGum AA) as a main matrix were compared to foaming ingredients comprising glucose syrup (e.g. DE21) or a linear polysaccharide (e.g. Fibruline XL) as a main matrix.

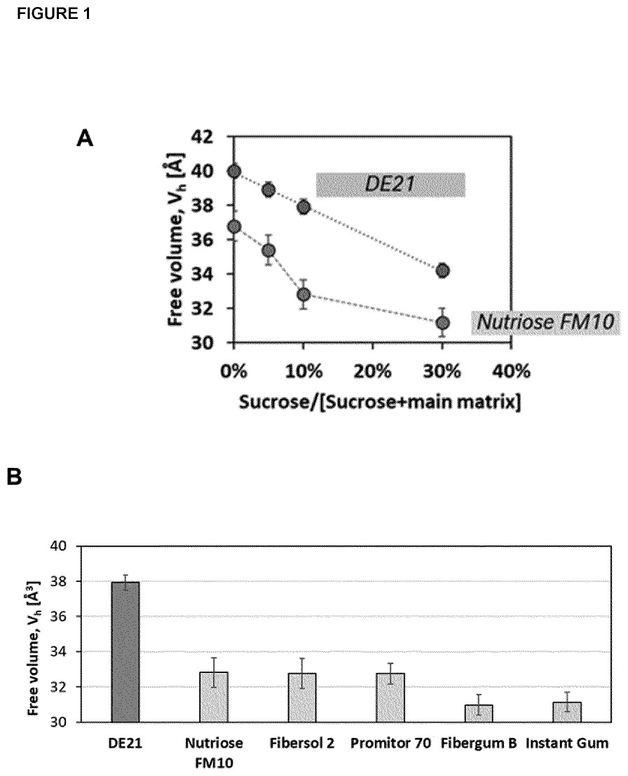

Addition of sucrose leads to a decrease in free volume when glucose syrup DE21 and Nutriose FM10 are used as main matrix. However, the free volume of the same recipe in all cases is lower when Nutriose FM10 is used as main matrix compared to DE21 (see FIG. 1A). All foaming ingredients comprising a branched polysaccharide had a lower free volume when compared to the booster base formed by DE21 as main matrix (see FIG. 1B). Free volume in a polymer can be defined as the volume of the total mass, that is not occupied by polymer chains themselves and hence diffusing molecules can be situated there. Therefore, lower free volume can be related to lower gas diffusion through the matrix, which corresponds to lower gas loss.

Nutriose FM10 and InstantGum AA were further compared to DE21 and Fibruline XL when the booster composition was: main matrix 77%, sucrose 14% and NaCas 9%. The foaming ingredient properties are shown in the table below.

| | | | Closed | | | |
|---|---|---|---|---|---|---|
| | | | porosity | T_{g} | M | a_{w} |
| Main matrix | Plasticizer | Protein | [%] | [°C] | [%] | [—] |
| Reference | | | 47-51 | >70 | 2.5-3 | ~0.11 |
| DE21 77% | Sucrose 14% | NaCas 9% | 51 | 82 | 2.9 | 0.09 |
| Fibruline XL 77% | Sucrose 14% | NaCas 9% | 47.7 | 59.6 | 2.1 | 0.1 |
| Nutriose FM10 77% | Sucrose 14% | NaCas 9% | 46.7 | 82 | 2.9 | 0.09 |
| InstantGum AA 77% | Sucrose 14% | NaCas 9% | 50.3 | 104 | 5 | 0.09 |

### Methods

The matrix density is determined by DMA 4500 M (Anton Paar, Switzerland AG). The sample is introduced into a U-shaped borosilicate glass tube that is excited to vibrate at its characteristic frequency which depends on the density of the sample. The accuracy of the instrument is 0.00005 g/cm³ for density and 0.03 °C for temperature. Sample preparation is performed as follows: 1 g of variant is dissolved in 100 g of demineralized water by magnetic agitation for 1 hour. Afterwards, sample is degassed in an ultrasonic bath (Sonorex) for 5 min. Matrix density is determined by comparing the exact weight of the sample and water to the density of water following the equation:

$$Matrix density = \frac{sample weight ( wt . \% )}{\frac{1}{density\_measured} - \frac{( water weight ( wt . \% ) )}{water density}}$$

Where sample weight in wt. % corresponds to the weight of the sample divided by the total amount of water and sample; and water weight in wt. % corresponds to the weight of water divided by the total amount of water and sample. The density of the water is 0.99816 g/cm³. Measurements were performed in triplicates. The apparent density of powders is measured by Accupyc 1330 Pycnometer (Micrometrics Instrument Corporation, US). The instrument determines density and volume by measuring the pressure change of helium in a calibrated volume with an accuracy to within 0.03% of reading plus 0.03% of nominal full-scale cell chamber volume.

Closed porosity is calculated from the matrix density and the apparent density, according to the following equation:

$$Closed porosity = 100 \cdot ( 1 - \frac{{ρ}_{apparent}}{{ρ}_{matrix}} )$$

Moisture content was determined by thermo-gravimetry analysis by using TG-DTA (Mettler Toledo Gmbh, Switzerland AG) or by Q600 (TA Instruments, US). This consists in recording the mass loss of any homogeneous material upon constant heating rate and under controlled dry gas flow conditions. Each sample of 25 mg (±5 mg) is submitted to a heating rate of 2 °C/min from 25 °C to 180 °C under dry nitrogen flow (100 mL/min). STARe ver. 11 software from Mettler-Toledo or TA Universal is used to analyse the TGA data for moisture content determination. The moisture content in g/100 g is the average of duplicates, with an uncertainty of 5%.

Water activity was measured by AquaLab 4TE Decagon (Decagon Devices Inc., US). The measurement is based on the detection of dew on the mirror when the sample has the same RH and temperature as the headspace of the measurement chamber. The instrument records the measurement every 5 minutes approximately. The water activity is the average of the last 15 minutes when the differences between water activities are below 0.001. The water activity accuracy from duplicates is ±0.007. All measurements are performed at 25.0 °C (±0.1 °C).

Glass transition temperatures (T_{g}) are measured by Differential Scanning Calorimetry (TA Instrument Q2000). A double scan procedure was used to erase the enthalpy of relaxation and get a better view on the glass transition. The scanning rate was 5 °C/min. The system was then cooled at 20 °C/min. The glass transition was detected during the second scan and defined as the onset of the step change of the heat capacity. The uncertainty of the measure is commonly ±3 °C.

The free volume was obtained by using Positron Annihilation Lifetime Spectroscopy (PALS). Measurements were conducted by placing the sample around a ²²Na positron source. The positron annihilation lifetime was determined by the time difference between a photon emission corresponding to the formation of a positron (start) and a photon emission produced during the annihilation of the positron (stop). These signals were detected using two different detectors. Samples were placed in a humidity chamber with saturated LiCl salt solution and measurements were performed after 35 hours to obtain stable positron lifetime and intensity levels. The hole radius was calculated using the Tao-Eldrup model and hole volume was calculated by assuming that the open volume is spherical. The concentration of free volume holes is linearly dependent on the intensity of the stop signal. Using the equation Fᵣ=I_{o-Ps}V_{f}, it is possible to calculate the relative fractional free volume in the sample where V_{f} is the average volume of free volume hole and I_{o-Ps} is the intensity of the stop signal.

### Example 4—Performance of Foaming Ingredients Comprising Branched Polysaccharides Results

| | | | Closed | | | | |
|---|---|---|---|---|---|---|---|
| Main | | | porosity | IGL | GLK | FV | FS |
| matrix | Plasticizer | Protein | [%] | [mL/g] | [%] | [cm³] | [%] |
| Reference | | | 47-51% | 8-12 | <50 | >40 | >70 |
| DE21 77% | Sucrose 14% | NaCas 9% | 51% | 7.1 | 33.3 | 45.4 | 78% |
| DE21 75% | Sucrose 13% | NaCas 12% | 47% | 6.8 | 38.8 | 42 | 76% |
| DE21 61% | DE47 30% | NaCas 9% | 49% | 8.4 | 29.2 | 39.8 | 75% |
| DE21 59% | DE47 29% | NaCas 12% | 50% | 8.7 | 30.8 | 53.1 | 74% |

| | | | Closed | | | | |
|---|---|---|---|---|---|---|---|
| Main | | | porosity | IGL | GLK | FV | FS |
| matrix | Plasticizer | Protein | [%] | [mL/g] | [%] | [cm³] | [%] |
| Reference | | | 47-51% | 8-12 | <50 | >40 | >70 |
| Nutriose | Sucrose | NaCas 9% | 46.7% | 7.4 | 15.2 | 40.9 | 78% |
| FM10 77% | 14% | | | | | | |
| Nutriose | DE47 20% | NaCas 9% | 47% | 7.3 | 27.8 | 40.9 | 76% |
| FM10 71% | | | | | | | |
| Nutriose | DE47 30% | NaCas 9% | 46.7% | 6.9 | 22.2 | 40.9 | 81% |
| FM10 61% | | | | | | | |

Samples with DE21 as main matrix and sucrose or DE47 as plasticizer present a GLK between 30 and 40% when the IGL is between 7 and 8.7 and the closed porosity is between 47 and 51%. In the case of Nutriose FM10, booster samples have lower GLK (between 15 and 28%) when IGL was between 7 and 7.5. All samples have a FV of 40 cm³ or greater and a FS greater than 70%.

In the table below, the closed porosity, IGL, GLK, foam volume and foam stability of linear and branched polysaccharides as main matrix are presented for the same composition and compared to the target values.

| | | | Closed | | | | |
|---|---|---|---|---|---|---|---|
| | | | porosity | IGL | GLK | FV | FS |
| Main matrix | Plasticizer | Protein | [%] | [mL/g] | [%] | [cm³] | [%] |
| Reference | | | 47-51% | 8-12 | <50 | >40 | >70 |
| DE21 77% | Sucrose 14% | NaCas 9% | 51% | 7.1 | 33.3 | 45.4 | 78% |
| Fibruline XL 77% | Sucrose 14% | NaCas 9% | 47.7 | 6.6 | 22.6 | 28.8 | 69% |
| Nutriose FM10 | Sucrose 14% | NaCas 9% | 46.7% | 7.4 | 15.2 | 40.9 | 78% |
| 77% | | | | | | | |
| InstantGum AA | Sucrose 14% | NaCas 9% | 50.3% | 9.2 | 11.6 | 43.1 | 74% |
| 77% | | | | | | | |

Branched polysaccharides (e.g. branched dextrins or arabinogalactans) generally perform better as main matrix when compared to linear polysaccharides (e.g. glucose syrup or inulin). Foaming ingredients in which the main matrix was a branched polymer present very low GLK values (below 15.2%) for similar closed porosities when compared to linear polymers. The low GLK of the foaming ingredient with inulin as main matrix can be explained by the low IGL, which is below 7 mL/g, and this foaming ingredient has very low foam volume (28.8 cm³).

### Methods

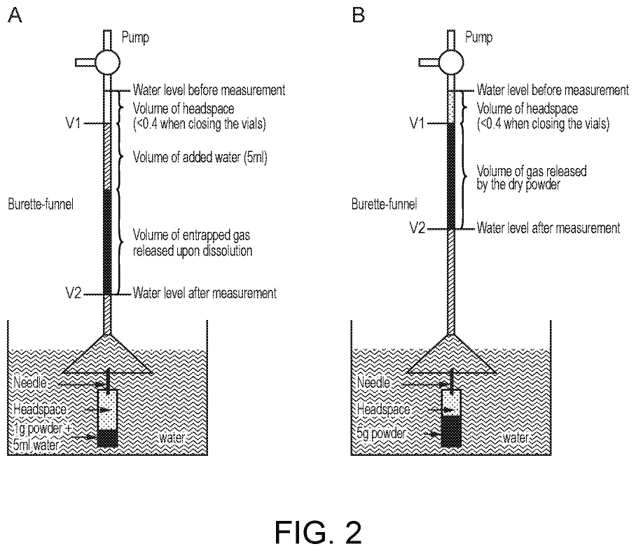

By dissolving the foaming ingredient in a sealed airtight vial, the entrapped gas will accumulate in the headspace and can then be transferred into an inverted burette filled with water to be quantified. This is the initial gas loading (IGL) (see FIG. 2A).

To calculate the gas loss kinetics (GLK), the foaming ingredient is sealed in a set of vials that are left at room temperature (between 20 °C and 25 °C) over increasing period of time (from 1 to 14 days). At each period, the gas that has been released from the foaming ingredient (and is still in the vial headspace) is transferred into an inverted burette filled with water (see FIG. 2B). The data (IGL and GLK data for 4 periods) are recorded allowing the prediction of the gas loss during its shelf life (over 12 months).

To determine foam volume, a dry mix of cappuccino was prepared in ambient conditions, containing: 1.9 g coffee, 3.9 g foaming ingredient, 4.6 g creamer, and 5 g sugar. In order to mimic consumers' habits, reconstitution is performed in a beaker of 6.5 cm diameter and 400 mL volume. The principle is to:
1. Add 200 mL of boiled water at 85 °C to the product.
2. Five seconds after the water addition, stir the beverage clockwise 20 times and counter-clockwise 20 times too. All stirring done in quick succession.
3. Measure the foam quantity immediately after the final stirring.

Foam stability was obtained by comparing the initial foam volume and the foam volume 5 minutes after the foam generation.

### EMBODIMENTS

Various preferred features and embodiments of the present invention will now be described with reference to the following numbered paragraphs (paras).

1. A foaming ingredient comprising carbohydrate and entrapped gas, wherein the carbohydrate comprises or consists of one or more branched polysaccharide.

2. The foaming ingredient according to para 1, wherein the one or more branched polysaccharide has a degree of branching of about 20% or more, about 25% or more, about 30% or more, about 35% or more, about 40% or more, about 45% or more, or about 50% or more, suitably wherein the degree of branching is determined by glycosyl-linkage analysis.

3. The foaming ingredient according to para 1 or 2, wherein the one or more branched polysaccharide has a conformation slope of about 0.49 or less, about 0.48 or less, about 0.47 or less, about 0.46 or less, about 0.45 or less, about 0.44 or less, or about 0.43 or less, suitably wherein the conformation slope is determined by triple detection size exclusion chromatography (SEC) in 0.1 M NaNO₃.

4. The foaming ingredient according to any preceding para, wherein the one or more branched polysaccharide has a Mark-Houwink-Sakurada (MHS) slope of about 0.40 or less, about 0.39 or less, about 0.38 or less, about 0.37 or less, or about 0.36 or less, suitably wherein the MHS slope is determined by triple detection SEC in 0.1 M NaNO₃.

5. The foaming ingredient according to any preceding para, wherein the one or more branched polysaccharide has a molecular mass of about 1 kDa or more.

6. The foaming ingredient according to any preceding para, wherein the one or more branched polysaccharide comprises or consists of one or more branched dextrin, one or more polydextrose, one or more arabinogalactan, or any combination thereof.

7. The foaming ingredient according to any preceding para, wherein the one or more branched polysaccharide comprises or consists of one or more branched dextrin.

8. The foaming ingredient according to any preceding para, wherein the one or more branched polysaccharide comprises or consists of one or more arabinogalactan.

9. The foaming ingredient according to any preceding para, wherein the foaming ingredient comprises the one or more branched polysaccharide in a total amount of from about 50 wt % to about 90 wt %, from about 55 wt % to about 90 wt %, or from about 60 wt % to about 90 wt %.

10. The foaming ingredient according to any preceding para, wherein the foaming ingredient comprises one or more emulsifier.

11. The foaming ingredient according to para 10, wherein the one or more emulsifier comprises or consists of protein, suitably wherein the protein comprises or consists of milk protein, plant protein, egg protein, or any combination thereof.

12. The foaming ingredient according to para 10 or 11, wherein the protein comprises or consists of:
(a) milk protein, optionally wherein the milk protein comprises or consists of one or more caseinate; and/or
(b) plant protein, optionally wherein the plant protein comprises or consists of pea protein, fava bean protein, chick pea protein, lentil protein, potato protein, wheat protein, soy protein, canola protein, rice protein, hemp protein, or any combination thereof.

13. The foaming ingredient according to any preceding para, wherein the foaming ingredient comprises one or more emulsifier in an amount of from about 5 wt % to about 30 wt %, from about 5 wt % to about 25 wt %, or from about 5 wt % to about 20 wt %, or from about 5 wt % to about 15 wt %.

14. The foaming ingredient according to any preceding para, wherein the foaming ingredient comprises one or more plasticizer.

15. The foaming ingredient according to para 14, wherein the one or more plasticizer comprises or consists of one or more maltodextrin, one or more glucose syrup, one or more monosaccharide (e.g. glucose, fructose, galactose), one or more disaccharide (e.g. sucrose, lactose, maltose), glycerol, one or more salts, one or more polyols, or any combination thereof, optionally wherein the one or more plasticizer comprises or consists of sucrose.

16. The foaming ingredient according to any preceding para, wherein the foaming ingredient comprises one or more plasticizer in an amount of from about 1 wt % to about 50 wt %, from about 2 wt % to about 50 wt %, from about 5 wt % to about 50 wt %, or from about 10 wt % to about 50 wt %.

17. The foaming ingredient according to any preceding para, wherein the foaming ingredient is in the form of a porous soluble powder.

18. The foaming ingredient according to para 17, wherein the foaming ingredient is in the form of a powder having a particle size distribution D_{3,2} from about 10 μm to about 500 μm.

19. The foaming ingredient according to any preceding para, wherein the foaming ingredient has a free volume of about 37×10⁻³⁰ m³ or less, about 36×10⁻³⁰ m³ or less, about 35×10⁻³⁰ m³ or less, about 34×10⁻³⁰ m³ or less, or about 33×10⁻³⁰ m³ or less, preferably wherein the free volume is determined by positron annihilation lifetime spectroscopy (PALS).

20. The foaming ingredient according to any preceding para, wherein the foaming ingredient has a glass-transition temperature (T_{g}) of from about 65 °C to about 110 °C, from about 65 °C to about 105 °C, from about 65 °C to about 100 °C, from about 65 °C to about 80 °C, from about 70 °C to about 95 °C, from about 70 °C to about 90 °C, or from about 75 °C to about 85 °C, preferably wherein the glass-transition temperature (T_{g}) is determined by differential scanning calorimetry (DSC).

21. The foaming ingredient according to any preceding para, wherein the foaming ingredient has a closed porosity of from about 20% to about 80%, from about 30% to about 70%, from about 40% to about 60%, from about 45% to about 55%, from about 46% to about 53%, or from about 47% to about 51%.

22. The foaming ingredient according to any preceding para, wherein the foaming ingredient has a moisture content of from about 0.5% to about 6%, from about 1% to about 5%, from about 2% to about 4%, or from about 2.5% to about 3.0%.

23. The foaming ingredient according to any preceding para, wherein the foaming ingredient has a water activity of from about 0.02 to about 0.20, from about 0.06 to about 0.16, from about 0.09 to about 0.13, or about 0.11.

24. The foaming ingredient according to any preceding para, wherein the entrapped gas is present in an amount of about 6.0 ml/g or more, about 6.5 ml/g or more, about 7.0 ml/g or more, about 7.5 ml/g or more, or about 8.0 ml/g or more.

25. The foaming ingredient according to any preceding para, wherein the foaming ingredient loses less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15% of the entrapped gas at room temperature over a period of 12 months.

26. The foaming ingredient according to any preceding para, wherein the foaming ingredient generates a foam volume of about 8 cm³/g or more, about 9 cm³/g or more, or about 10 cm³/g or more, when reconstituted in liquid.

27. The foaming ingredient according to para 26, wherein about 60% or more, about 65% or more, about 70% or more, or about 75% or more of the foam volume is retained 5 minutes after the foam generation.

28. A method for preparing a foaming ingredient, comprising the steps of:
(a) providing an aqueous mixture comprising carbohydrate, wherein the carbohydrate comprises or consists of one or more branched polysaccharide;
(b) spray-drying the aqueous mixture to provide a porous powder; and
(c) gas-loading the porous powder to provide a foaming ingredient comprising entrapped gas.

29. The method according to para 28, wherein the one or more branched polysaccharide has a degree of branching of about 20% or more, about 25% or more, about 30% or more, about 35% or more, about 40% or more, about 45% or more, about 50% or more, suitably wherein the conformation slope is determined by triple detection size exclusion chromatography (SEC) in 0.1 M NaNO₃.

30. The method according to para 28 or 29, wherein the one or more branched polysaccharide has a conformation slope of about 0.49 or less, about 0.48 or less, about 0.47 or less, about 0.46 or less, about 0.45 or less, about 0.44 or less, or about 0.43 or less, suitably wherein the conformation slope is determined by triple detection size exclusion chromatography (SEC) in 0.1 M NaNO₃.

31. The method according to any of paras 28-30, wherein the one or more branched polysaccharide has a Mark-Houwink-Sakurada (MHS) slope of about 0.40 or less, about 0.38 or less, or about 0.36 or less, suitably wherein the MHS slope is determined by triple detection SEC in 0.1 M NaNO₃.

32. The method according to any of paras 28-31, wherein the one or more branched polysaccharide has a molecular mass of about 1 kDa or more.

33. The method according to any of paras 28-32, wherein the one or more branched polysaccharide comprises or consists of one or more branched dextrin, one or more polydextrose, one or more arabinogalactan, or any combination thereof.

34. The method according to any of paras 28-33, wherein the one or more branched polysaccharide comprises or consists of one or more branched dextrin.

35. The method according to any of paras 28-34, wherein the one or more branched polysaccharide comprises or consists of one or more arabinogalactan.

36. The method according to any of paras 28-35, wherein the aqueous mixture comprises the one or more branched polysaccharide in a total amount of from about 50 wt % to about 90 wt %, from about 55 wt % to about 90 wt %, or from about 60 wt % to about 90 wt %, on a dry weight basis.

37. The method according to any of paras 28-36, wherein the aqueous mixture comprises one or more emulsifier.

38. The method according to para 37, wherein the one or more emulsifier comprises or consists of protein, suitably wherein the protein comprises or consists of milk protein, plant protein, egg protein, or any combination thereof.

39. The method according to para 37 or 38, wherein the protein comprises or consists:
(a) of milk protein, optionally wherein the milk protein comprises or consists of one or more caseinate; and/or
(b) plant protein, optionally wherein the plant protein comprises or consists of pea protein, fava bean protein, chick pea protein, lentil protein, potato protein, wheat protein, soy protein, canola protein, rice protein, hemp protein, or any combination thereof.

40. The method according to any of paras 28-39, wherein the aqueous mixture comprises protein in an amount of from about 5 wt % to about 30 wt %, from about 5 wt % to about 25 wt %, or from about 5 wt % to about 20 wt %, or from about 5 wt % to about 15 wt %, on a dry weight basis.

41. The method according to any of paras 28-40, wherein the aqueous mixture comprises one or more plasticizer.

42. The method according to para 41, wherein the one or more plasticizer comprises or consists of one or more maltodextrin, one or more glucose syrup, one or more disaccharide, (e.g. sucrose, lactose, maltose), glycerol, one or more salts, one or more polyols, or any combination thereof, optionally wherein the one or more plasticizer comprises or consists of sucrose.

43. The method according to any of paras 28-42, wherein the aqueous mixture comprises one or more plasticizer in an amount such that the glass-transition temperature (T_{g}) of the foaming ingredient is from about 65 °C to about 80 °C.

44. The method according to any of paras 28-43, wherein the aqueous mixture comprises one or more plasticizer in an amount of from about 1 wt % to about 50 wt %, from about 2 wt % to about 50 wt %, from about 5 wt % to about 50 wt %, or from about 10 wt % to about 50 wt %, on a dry weight basis.

45. The method according to any of paras 28-44, wherein the aqueous mixture is mixed with a high shear mixer.

46. The method according to any of paras 28-45, wherein the aqueous mixture, or at least part thereof, is homogenised.

47. The method according to any of paras 28-46, wherein the aqueous mixture is pasteurised.

48. The method according to any of paras 28-47, wherein prior to spray-drying the aqueous mixture has a viscosity of from about 50 mPa·s to about 100 mPa·s at a temperature of 60 °C and a shear rate of 100 s⁻¹.

49. The method according to any of paras 28-48, wherein prior to spray-drying the aqueous mixture has a total solids (TS) of about 35% or more, about 40% or more, about 45% or more, or about 50% or more.

50. The method according to any of paras 28-49, wherein the gas loaded into the porous powder comprises or consists of nitrogen, air, carbon dioxide, argon, or any combination thereof.

51. The method according to any of paras 28-50, wherein during gas-loading the porous powder is: (i) subjected to a pressure of from about 10 bar to about 200 bar, from about 20 bar to about 100 bar, or from about 35 bar to about 55 bar; and a temperature of from about 10 °C to about 30 °C, or from about 15 °C to about 25 °C above the glass transition temperature of the porous powder, above the glass transition temperature of the porous powder.

52. The method according to para 51, wherein the porous powder is subsequently: (ii) cooled below its glass transition temperature; and (iii) depressurised.

53. The method according to any of paras 28-52, wherein the foaming ingredient is defined according to any of paras 1-27.

54. A foaming ingredient obtained or obtainable by the method according to any of paras 28-53.

55. A soluble beverage powder comprising a foaming ingredient according to any of paras 1-27 or para 54.

56. The soluble beverage powder according to para 55, wherein the soluble beverage powder is a creamer or a foamer.

57. A foaming beverage or foodstuff comprising a foaming ingredient according to any of paras 1-27 or para 54, or a soluble beverage powder according to para 55 or 56.

58. The foaming beverage or foodstuff according to para 57, wherein the foaming beverage or foodstuff is selected from cappuccino-type beverages, milkshakes, instant chocolate drinks, instant tea, soups, sauces, and desserts.

59. Use of a foaming ingredient according to any of paras 1-27 or para 54, or a soluble beverage powder according to para 55 or 56, to prepare a foaming beverage or foodstuff.

60. The use according to para 59, wherein the foaming beverage or foodstuff is selected from cappuccino-type beverages, milkshakes, instant chocolate drinks, instant tea, soups, sauces, and desserts.

1: A foaming ingredient comprising carbohydrate and entrapped gas, wherein the carbohydrate comprises one or more branched polysaccharide.

2: The foaming ingredient according to claim 1, wherein the one or more branched polysaccharide has at least one of: (i) a degree of branching of about 20% or more; (ii) a conformation slope of about 0.49 or less; and/or (iii) a Mark-Houwink-Sakurada (MHS) slope of about 0.40 or less.

3: The foaming ingredient according to claim 1, wherein the one or more branched polysaccharide comprises at least one of one or more branched dextrin, one or more polydextrose, one or more arabinogalactan, or any combination thereof.

4: The foaming ingredient according to claim 1, wherein the foaming ingredient comprises the one or more branched polysaccharide in a total amount from about 50 wt % to about 90 wt %.

5: The foaming ingredient according to claim 1, wherein the foaming ingredient comprises one or more emulsifier in an amount from about 5 wt % to about 30 wt %.

6: The foaming ingredient according to claim 1, wherein the foaming ingredient comprises one or more plasticizer in an amount from about 1 wt % to about 50 wt %.

7: The foaming ingredient according to claim 1, wherein the foaming ingredient is a porous soluble powder.

8: The foaming ingredient according to claim 1, wherein the entrapped gas is present in an amount of about 6.0 ml/g or more.

9: The foaming ingredient according to claim 1, wherein the foaming ingredient loses less than about 30% of the entrapped gas at room temperature over a period of 12 months.

10: The foaming ingredient according to claim 1, wherein the foaming ingredient generates a foam volume of about 8 cm³/g or more.

11: A method for preparing a foaming ingredient, the method comprising:
(a) providing an aqueous mixture comprising carbohydrate, wherein the carbohydrate comprises one or more branched polysaccharide;
(b) spray-drying the aqueous mixture to provide a porous powder; and
(c) gas-loading the porous powder to provide a foaming ingredient comprising entrapped gas.

12: A foaming ingredient obtained or obtainable by the method according to claim 11.

13: A soluble beverage powder comprising a foaming ingredient, the foaming ingredient comprising carbohydrate and entrapped gas, wherein the carbohydrate comprises one or more branched polysaccharide.

14: A foaming beverage or foodstuff comprising a foaming ingredient, the foaming ingredient comprising carbohydrate and entrapped gas, wherein the carbohydrate comprises one or more branched polysaccharide.

15. (canceled)

16: The foaming ingredient according to claim 1, wherein the one or more branched polysaccharide has a degree of branching of about 50% or more.

17: The foaming ingredient according to claim 1, wherein the one or more branched polysaccharide has a conformation slope of about 0.43 or less.

18: The foaming ingredient according to claim 1, wherein the one or more branched polysaccharide has a Mark-Houwink-Sakurada (MHS) slope of about 0.36 or less.

19: The foaming ingredient according to claim 1, wherein the foaming ingredient comprises the one or more branched polysaccharide in a total amount of about 60 wt % to about 90 wt %.

20: The foaming ingredient according to claim 1, wherein the foaming ingredient comprises one or more emulsifier in an amount from about 5 wt % to about 15 wt %.

21: The foaming ingredient according to claim 1, wherein the foaming ingredient comprises one or more plasticizer in an amount from about 10 wt % to about 50 wt %.
